(19) United States
(12) Patent Application Publication
(10) Pub. No.: US 2007/0252327 A1
(43) Pub. Date: Nov. 1, 2007

(54) Stepped Position Specifying Apparatus, Stepping Type Exercise Apparatus, Stepped Position Specifying Method and Exercising Support Method

(76) Inventors: Hiromu Ueshima, Shiga (JP); Masaki Ohashi, Shiga (JP)

Correspondence Address: JEROME D. JACKSON (JACKSON PATENT LAW OFFICE), 211 N. UNION STREET, SUITE 100, ALEXANDRIA, VA, 22314, US

(21) Appl. No.: 11/568,805

(22) PCT Filed: May 9, 2005
(86) PCT No.: PCT/JP05/08816

§ 371 Date: Nov. 8, 2006

(51) Int. Cl. A63F 13/02

(52) U.S. Cl. 273/148 B

(57) ABSTRACT

Mat 40 includes foot switches FS1 to FS4. The information processing apparatus 20 attached to the mat 40 displays moving objects 118-1 to 118-4 which move in motion lanes 120-1 to 120-4 and response objects 114-1 to 114-4 corresponding to foot switches FS1 to FS4 on the television monitor 1. The response object is responsive to the operation of the corresponding foot switch. The player can operate the response objects 114-1 to 114-4 and hit the moving objects 118-1 to 118-4 by stepping on the foot switches FS1 to FS4. While any the foot switches are being turned on, the form of the corresponding response object(s) is different from the form of response object(s) displayed when the foot switches are being turned off.

This application claims foreign priority based on Japanese Patent application No. 2004-140859, filed May 11, 2004, the contents of which is incorporated herein by reference in its entirety.

### 1. TECHNICAL FIELD

The present invention is related to a stepped position specifying apparatus which shows the foot switch(es) stepped by a player and the related techniques thereof.

### 2. BACKGROUND ART

A ball paddle game apparatus of the present applicant is described in Jpn. unexamined patent publication No. 2001-104635 (corresponding U.S. Pat. No. 6,607,436) (referred to as the Patent Document in the following explanation). This will be briefly explained.

FIG. 40 is a view showing the overall configuration of the ball paddle game apparatus described in the Patent Document. As shown in FIG. 40, this ball paddle game apparatus includes a game console 501, which can be connected to a television monitor 500. This game console 501 is provided with four paddle keys 502 to 505.

FIG. 41 is a view showing an example of the game screen displayed on the television monitor 500 by the ball paddle game apparatus disclosed in the Patent Document. Four paddle images 602 to 605 are displayed in the game screen corresponding to the four paddle keys 502 to 505. Also, balls 510 are displayed to move along four ball motion lanes “A” to “D” corresponding to the four paddle images 602 to 605. When any or all of the paddle keys 502 to 505 are pressed down, the paddle image corresponding to the pressed paddle key hits the ball 510 on the corresponding ball motion lane. If the operation timing of the paddle keys 502 to 505 coincides with the motion timing of the balls 510, the player succeeds, otherwise fails.

If the balls 510 are displayed to fall in synchronization with music, the player can enjoy the game together with music.

Alternatively, it is possible to use a plurality of foot switches which detect footsteps instead of using the paddle keys 502 to 505 though this is not an example of prior art.

In case of the paddle keys 502 to 505, the player can easily recognize which paddle key the player is pressing down.

However, in case of the foot switches, the player can not easily recognize which foot switch the player is stepping on unless the player looks at own steps.

### SUMMARY OF INVENTION

It is an object of the present invention to provide a stepped position specifying apparatus which a player can easily recognize which foot switch the player is stepping on without looking at own steps and the related techniques thereof.

In accordance with a first aspect of the present invention, a stepped position specifying apparatus connected to a display device when being used, said stepped position specifying apparatus comprises a mat which has a plurality of foot switches operable to detect stepping operation; an image generating unit operable to generate images of a plurality of response objects which are responsive respectively to the operation of the corresponding foot switch, and display the images on the display device; and a response object control unit operable to, during the period when the foot switch is turned on, display the corresponding response object in a different manner from the response object displayed while the foot switch is being turned off.

In accordance with this configuration, during the period when the foot switch is turned on, the corresponding response object is displayed in the different manner from the response object displayed when the foot switch is turned off. Therefore, the player can easily recognize which the foot switch the player is treading on without looking at own steps. As a result, the player can operate the plurality of foot switches more easily, and therefore can concentrate on the display device.

In the above stepped position specifying apparatus, said response object control unit, during the period when the foot switch is turned on, displays the corresponding response object in a different form from the response object displayed while the foot switch is being turned off.

In accordance with this configuration, during the period when the foot switch is turned on, the form of corresponding response object is different from the response object displayed when the foot switch is turned off. Therefore, the player can easily recognize which the foot switch the player is treading on without looking at own steps.

In the above stepped position specifying apparatus, the different form of the response object is expressed by shape, pattern, color or combination thereof.

In accordance with a second aspect of the present invention, a stepping type exercise apparatus connected to a display device when being used, said stepping type exercise apparatus comprises a mat which has a plurality of foot switches operable to detect stepping operation; an image generating unit operable to generate images of a plurality of response objects which are responsive respectively to the operation of the corresponding foot switch and images of moving objects which move in motion lanes corresponding to the response objects, and display the images on the display device; a music play back unit operable to play back music in accordance with musical score data; a moving object control unit operable in order that each moving object is displayed on the motion lane corresponding to each moving object in accordance with display timing setting data which is used to set display timing in synchronization with the music; and a response object control unit operable to change, when the foot switch is operated, the way of displaying the response object corresponding to the operated foot switch, wherein said moving object control unit moves the moving object along the corresponding motion lane, and changes the way of displaying the moving object if the corresponding foot switch is operated while the moving object is located within a predetermined area of the corresponding motion lane, and wherein said response object control unit displays, during the period when the foot switch is turned on, the corresponding response object in a different manner from the response object displayed while the foot switch is being turned off.

In accordance with this configuration, the player can enjoy operating the response object to make changes to the moving object by treading on the foot switch with music. In addition, during the period when the foot switch is turned on, the corresponding response object is displayed in the different manner from the response object displayed when the foot switch is turned off. Therefore, the player can easily recognize which the foot switch the player is treading on without looking at own steps. As a result, the player can operate the plurality of foot switches more easily, and therefore can concentrate on the display device.

In accordance with a third aspect of the present invention, a stepping type exercise apparatus connected to a display device when being used, said stepping type exercise apparatus comprises a mat which has a plurality of foot switches operable to detect stepping operation; an image generating unit operable to generate images of a plurality of response objects which are responsive respectively to the operation of the corresponding foot switch and images of moving objects which move in motion lanes corresponding to the response objects, and display the images on the display device; a music play back unit operable to play back music in accordance with musical score data; a moving object control unit operable in order that each moving object is displayed on the motion lane corresponding to each moving object in accordance with display timing setting data which is used to set display timing in synchronization with the music; an response object control unit operable to change, when the foot switch is operated, the way of displaying the response object corresponding to the operated foot switch; a playing time setting unit operable to set a playing time in response to information input by a player; and an exit control unit operable, after the playing time that is set elapses, to control said music play back unit to stop play backing the music, and/or to control said image generating unit to generate an image which directly or indirectly indicates the end, wherein said moving object control unit moves the moving object along the corresponding motion lane, and changes the way of displaying the moving object if the corresponding foot switch is operated while the moving object is located within a predetermined area of the corresponding motion lane.

In accordance with this configuration, the player can set the desired play time. The player can operate the response object by stepping on the foot switch to make changes to the moving object during the play time. In addition, the player can enjoy stepping operation with music. In this way, the player can play monotonous stepping operation with enjoyment.

In accordance with a fourth aspect of the present invention, a stepping type exercise apparatus connected to a display device when being used, said stepping type exercise apparatus comprises a mat which has a plurality of foot switches operable to detect stepping operation; an image generating unit operable to generate images of a plurality of response objects which are responsive respectively to the operation of the corresponding foot switch and images of moving objects which move in motion lanes corresponding to the response objects, and display the images on the display device; a music play back unit operable to play back music in accordance with musical score data; a moving object control unit operable in order that each moving object is displayed on the motion lane corresponding to each moving object in accordance with display timing setting data which is used to set display timing in synchronization with the music; an response object control unit operable to change, when the foot switch is operated, the way of displaying the response object corresponding to the operated foot switch; a number setting unit operable to set the number of music pieces to be played back or the number of times the music is played back in accordance with information which is input by a player; and an exit control unit operable to control said image generating unit to generate an image which directly or indirectly indicates the end after completion of play back of the music through the number of music pieces or the number of times that is set, wherein said moving object control unit moves the moving object along the corresponding motion lane, and changes the way of displaying the moving object if the corresponding foot switch is operated while the moving object is located within a predetermined area of the corresponding motion lane.

In this configuration, the player can set the desired number of music pieces to be played back or the number of times one music is played back. While the music is playing back, the player can operate the response object by stepping on the foot switch to make changes to the moving object. In addition, the player can enjoy stepping operation with music. In this way, the player can play monotonous stepping operation with enjoyment.

In the above stepping type exercise apparatus, said music play back unit play backs a plurality of different music pieces in a fixed order or in an order which is dynamically determined, and said moving object control unit appear makes each moving object appear on the motion lane corresponding to each moving object in accordance with display timing setting data which is used to set display timing in synchronization with the music.

In this configuration, the plurality of different music pieces is play backed, therefore the player can continue stepping operation without growing weary.

In the above stepping type exercise apparatus, said response object control unit, during the period when the foot switch is turned on, displays the corresponding response object in a different manner from the response object displayed while the foot switch is being turned off.

In this configuration, the player can easily recognize which the foot switch the player is treading on without looking at own steps. As a result, the player can operate the plurality of foot switches more easily, and therefore can concentrate on the display device.

### BRIEF DESCRIPTION OF DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1 is a view showing the overall configuration of an entertainment system in accordance with the embodiment of the present invention.

FIG. 2 is a plan view of the mat of FIG. 1.

FIG. 3 is a side back view of the mat of FIG. 40.

FIG. 4 is an exploded perspective view showing the structure of the mat of FIG. 1.

FIG. 5A is a plan view illustrating the upper electrode sheet of FIG. 4.

FIG. 5B is a plan view illustrating the spacer of FIG. 4.

FIG. 5C is a plan view illustrating the lower electrode sheet of FIG. 4.

FIG. 6 is a view showing an example of the play screen in the fitness mode.

FIG. 7 is a view for explaining a hit range “HR” in this embodiment.

FIG. 8 is a view showing other example of the play screen in the fitness mode in accordance with the present embodiment.

FIG. 9 is a view showing an example of the play time setting screen of the fitness mode in accordance with the present embodiment.

FIG. 10 is a view showing an example of ending screen of the fitness mode in accordance with the present embodiment.

FIG. 11 is a view showing an example of play screen in accordance with the present embodiment.

FIG. 12 is a view showing the electrical construction of the information processing apparatus as illustrated in FIG. 1.

FIG. 13 is a block diagram illustrating the high-speed processor of FIG. 12.

FIG. 14 is a schematic representation of the control program and data stored in the ROM of FIG. 12.

FIG. 15 is a schematic representation of an example of the musical score data of FIG. 14.

FIG. 16 is a schematic representation of an example of the musical score data for melody of FIG. 15.

FIG. 17 is a schematic representation of an example of the musical score data for registering moving objects of FIG. 15.

FIG. 18 is a view showing the relation between the note numbers used in the musical score data for registering moving objects of FIG. 17, the moving objects and the motion lanes.

FIG. 19 is a schematic representation of an example of the musical score data for registering stepping sound indicating information of FIG. 15.

FIG. 20 is a view showing an example of the stepping sound setting table stored in the ROM of FIG. 12.

FIG. 21 is a flowchart showing the overall process flow of the information processing apparatus of FIG. 1.

FIG. 22 is a flowchart showing the process flow of the fitness mode in step S6 of FIG. 21.

FIG. 23 is a flowchart showing the process flow of the play time setting process in step S24 of FIG. 22.

FIG. 24 is a flowchart showing the process flow of the music order setting process in step S26 of FIG. 22.

FIG. 25 is a flowchart showing the process flow of the stepping location detecting process in step S29 of FIG. 22.

FIG. 26 is a flowchart showing the process flow of the stepping detecting process in step S30 of FIG. 22.

FIG. 27 is a flowchart showing the process flow of the moving object control process in step S31 of FIG. 22.

FIG. 28 is a flowchart showing the process flow of the process which is performed after “No” is judged in step S84 of FIG. 27.

FIG. 29 is a flowchart showing the process flow of the response object control process in step S32 of FIG. 22.

FIG. 30 is a view showing the animation tables of the response object “114-J” in this present embodiment.

FIG. 31 is a flowchart showing the process flow of the stepping number detecting process in step S33 of FIG. 22.

FIG. 32 is a flowchart showing the process flow of the music setting process in step S34 of FIG. 22.

FIG. 33 is a view showing the relation among the music number, the start address of the musical score data for melody and the musical score data for melody.

FIG. 34 is a flowchart showing the process flow of the sound process in step S9 of FIG. 21.

FIG. 35 is a flowchart showing the process flow of the melody playback in step S200 of FIG. 34.

FIG. 36 is a flowchart showing the process flow of registering the moving objects in step S201 of FIG. 34.

FIG. 37 is a flowchart showing the process flow of registering the stepping sound indicating information in step S202 of FIG. 34.

FIG. 38 is a flowchart showing the process flow of outputting sound in response to stepping operation in step S203 of FIG. 34.

FIG. 39A to 39G are views showing examples of images showing stepping position in the present invention.

FIG. 40 is a view showing the overall configuration of the conventional ball paddle game apparatus described in the Patent Document.

FIG. 41 is a view showing an example of the game screen of the conventional ball paddle game apparatus disclosed in the Patent Document.

### DESCRIPTION OF THE PREFERRED EMBODIMENTS

In what follows, an embodiment of the present invention will be explained in conjunction with the accompanying drawings. Meanwhile, like references indicate the same or functionally similar elements throughout the respective drawings, and therefore redundant explanation is not repeated.

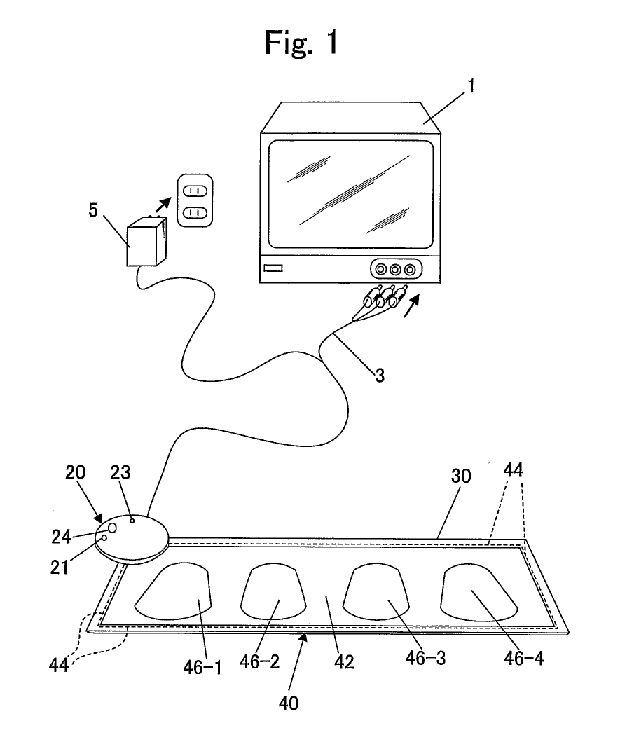

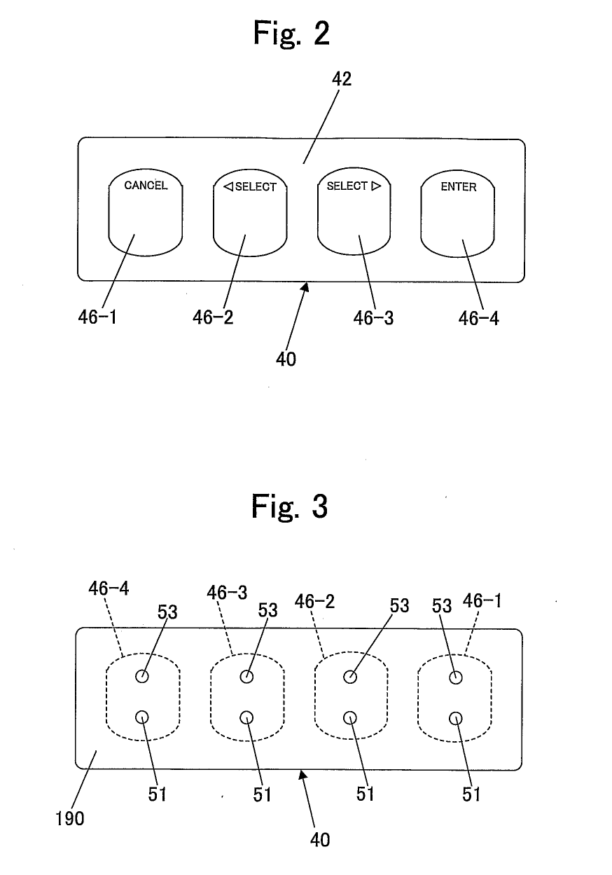

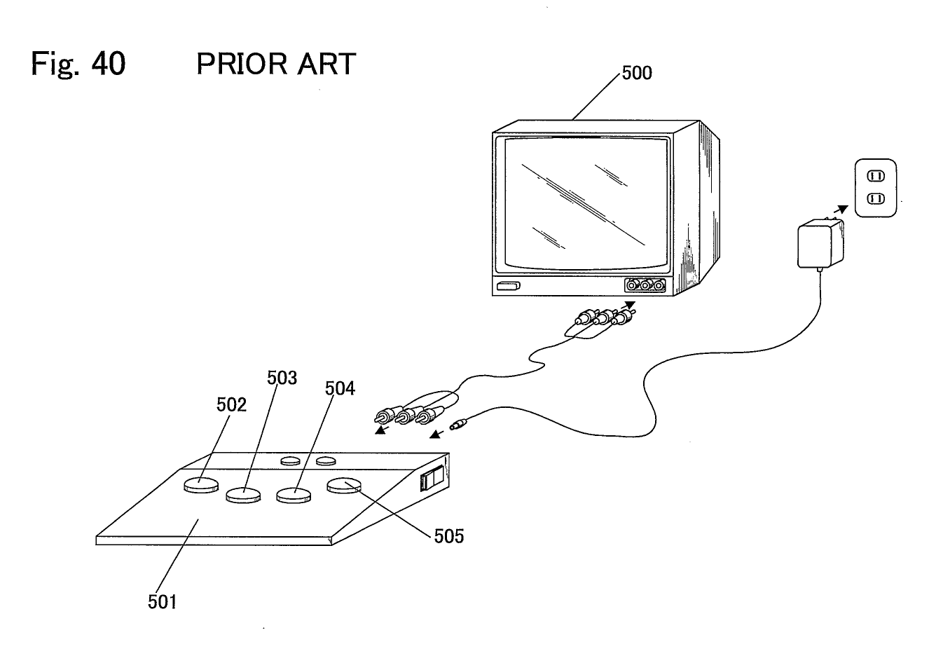

FIG. 1 is a view showing the overall configuration of an entertainment system in accordance with the embodiment of the present invention. FIG. 2 is a plan view of a mat 40 of FIG. 1. FIG. 3 is a side back view of the mat 40 of FIG. 40. As illustrated in FIG. 1, the entertainment system is provided with a television monitor 1, an information processing apparatus 20 and the mat 40. The television monitor 1 and the information processing apparatus 20 are connected with an AV cable 3. A DC power voltage is supplied to the information processing apparatus 20 through an AC adapter 5. Alternatively, it is possible to use batteries (not shown) to supply the DC power voltage in place of the AC adapter 5.

The information processing apparatus 20 is provided, on the upper surface of its housing, with a power supply switch 24, a reset switch 21 to reset the system and a power lamp 23 which is lighted when the power supply switch 24 is turned on. The mat 40 has four foot switches FS1 to FS4 (to be described below). When the power switch 24 is turned on, the information processing apparatus 20 performs information processing in response to on/off information of the foot switches FS1 to FS4 built in the mat 40.

In the following description, the term “foot switch FSJ” (J=1 to 4) is generally used to represent the foot switches FS1 to FS4.

As illustrated in FIG. 2, four stepping regions 46-1 to 46-4 are formed corresponding to the four foot switches FS1 to FS4 on a top sheet 42 as a top layer of the mat 40. Therefore, the player can turn any of the foot switches FS1 to FS4 on by stepping on the stepping regions 46-1 to 46-4. For example, the stepping regions 46-1 to 46-4 are screen-printed on the surface of the top sheet 42.

In the following description, the term “stepping region 46-J” (J=1 to 4) is generally used to represent the stepping regions 46-1 to 46-4.

The four foot switches FS1 to FS4 corresponding to the four stepping regions 46-1 to 46-4 are used for inputting in the game mode and the fitness mode to be described below. Incidentally, the four foot switches FS1 to FS4 corresponding to the four stepping regions 46-1 to 46-4 are sometimes used respectively as a cancel switch, a left select switch, a right select switch and a decision switch. Therefore, words such as “cancel”, “select”, “select” and “enter” are printed on the corresponding stepping regions 46-1 to 46-4.

As illustrated in FIG. 3, four pairs of cleats 51 and 53 are attached on the surface of the bottom sheet 190. In this case, the pair of cleats 51 and 53 is attached to position corresponding to the stepping region “46-J”. The cleats 51 and 53 are, for example, made of silicon, polyurethane or synthetic rubber.

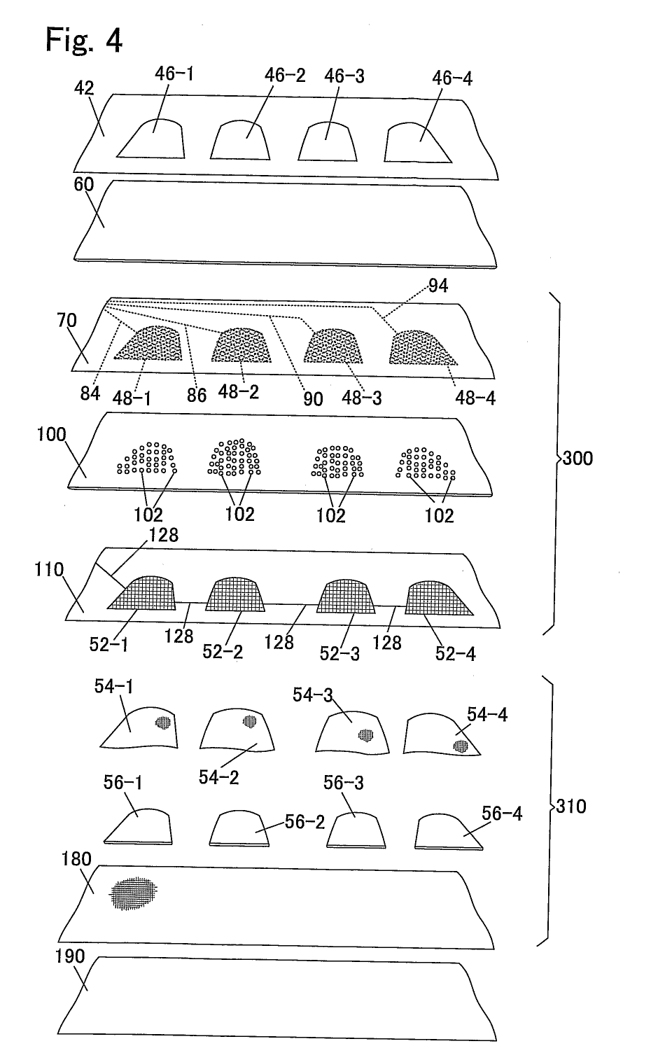

FIG. 4 is an exploded perspective view showing the structure of the mat 40 of FIG. 1. As illustrated in FIG. 4, the mat 40 is provided with the bottom sheet 190, a fabric sheet 140, pads 56-1 to 56-4, fabric sheets 54-1 to 54-4, a lower electrode sheet 110, an insulative spacer 100, an upper electrode sheet 70, a shock-absorbing sheet 60 and the top sheet 42.

The mat 40 has the bottom sheet 190 disposed at the bottommost layer thereof, the fabric sheet 180 upwardly positioned on the bottom sheet 190, the pads 56-1 to 56-4 upwardly provided on the fabric sheet 180, the fabric sheets 54-1 to 54-4 upwardly disposed on the pads 56-1 to 56-4, the lower electrode sheet 110 upwardly located on the fabric sheets 54-1 to 54-4, the spacer 100 upwardly positioned on the lower electrode sheet 110, the upper electrode sheet 70 upwardly disposed on the spacer 100, the shock-absorbing sheet 60 upwardly located on the upper electrode sheet 70, and the top sheet 42 provided on the top of the shock-absorbing sheet 60, i.e., at the topmost layer of the mat 40.

The lower electrode sheet 110 is formed with electrically conductive regions 52-1 to 52-4 and 128. The spacer 100 has a plurality of apertures 102 defined at regions corresponding with respective positions of the electrically conductive regions 52-1 to 52-4. The upper electrode sheet 70 is formed with electrically conductive regions 48-1 to 48-4 that correspond with the electrically conductive regions 52-1 to 52-4 on the lower electrode sheet 110, respectively. The upper electrode sheet 70 is also formed with further electrically conductive regions 84, 86, 90 and 94. The lower electrode sheet 110, the spacer 100 and the upper electrode sheet 70 are laminated together in such a manner that the spacer 100 is sandwiched between the electrically conductive regions 52-1 to 52-4 on the lower electrode sheet 110 and the electrically conductive regions 48-1 to 48-4 on the upper electrode sheet 70 in a state in which the electrically conductive regions 52-1 to 52-4 on the lower electrode sheet 110 squarely face the electrically conductive regions 48-1 to 48-4 on the upper electrode sheet 70, respectively. Accordingly, the electrically conductive regions 52-1 to 52-4 are formed on the upper surface of the lower electrode sheet 110, while the electrically conductive regions 48-1 to 48-4 are formed on the lower surface of the upper electrode sheet 70. In FIG. 4, the electrically conductive regions 48-1 to 48-4 are illustrated by dashed lines because they are formed on the under surface of the upper electrode sheet 70.

The lower electrode sheet 110, the spacer 100 and the upper electrode sheet 70 form a switch layer 300. The electrically conductive region 52-1 on the lower electrode sheet 110, the electrically conductive region 48-1 on the upper electrode sheet 70, and a corresponding region including the apertures 102 on the spacer 100 form the foot switch FS1. The electrically conductive region 52-2 on the lower electrode sheet 110, the electrically conductive region 48-2 on the upper electrode sheet 70, and a corresponding region including the apertures 102 on the spacer 100 form the foot switch FS2. The electrically conductive region 52-3 on the lower electrode sheet 110, the electrically conductive region 48-3 on the upper electrode sheet 70, and a corresponding region including the apertures 102 on the spacer 100 form the foot switch FS3. The electrically conductive region 52-4 on the lower electrode sheet 111, the electrically conductive region 48-4 on the upper electrode sheet 70, and a corresponding region including the apertures 102 on the spacer 100 form the foot switch FS4. The foot switches FS1 to FS4 as just discussed above can be, e.g., membrane switches.

The top sheet 42 as well as the bottom sheet 190 is made from, e.g., polyvinyl chloride of a non-phthalic acid series. The shock-absorbing sheet 60 as well as the spacer 100 can be, e.g., a spongy sheet of some 4 mm in thickness. The electrode sheets 70 and 110 can be, e.g., transparent sheets fabricated from polypropylene. The fabric sheets 54-1 to 54-4 and 180 can be, e.g., thin sheets. The pads 56-1 to 56-4 are made from, e.g., polyurethane, each of which is some 8 mm in thickness.

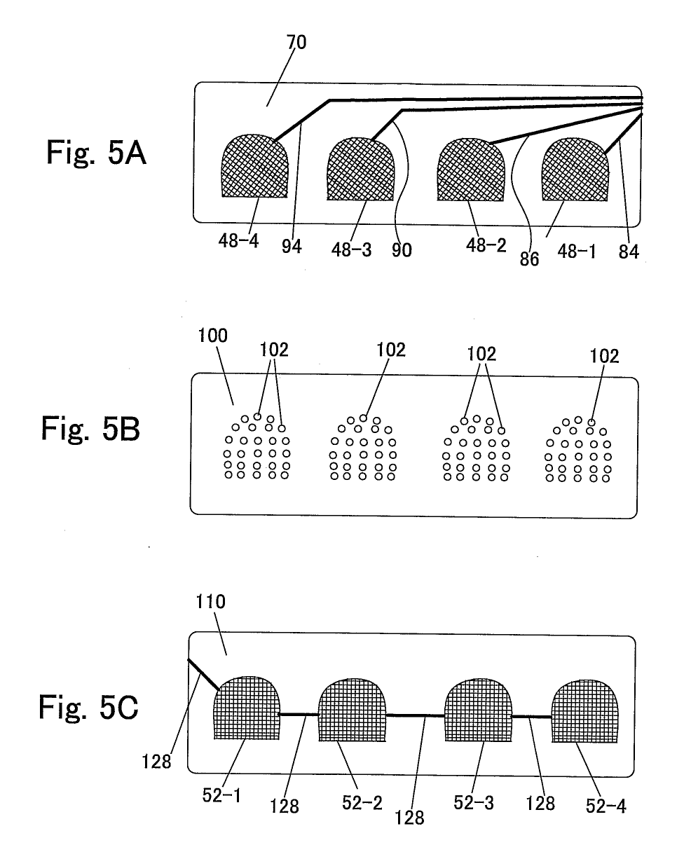

FIG. 5A is a plan view illustrating the upper electrode sheet 70 of FIG. 4. FIG. 5B is a plan view illustrating the spacer of FIG. 4. FIG. 5C is a plan view illustrating the lower electrode sheet 110 of FIG. 4.

As illustrated in FIG. 5A, each of the electrically conductive regions 48-1 to 48-4 is formed by the formation of lattice-shaped electrical conductor patterns on the underside of the upper electrode sheet 70. The electrically conductive regions 84, 86, 90 and 94 extend from the electrically conductive regions 48-1 to 48-4, respectively, toward an edge of the upper electrode sheet 70. Each of the electrically conductive regions 84, 86, 90 and 94 is formed by the formation of lattice-shaped electrical conductor patterns (not shown) on the underside of the upper electrode sheet 70.

As illustrated in FIG. 5C, each of the electrically conductive regions 52-1 to 52-4 is formed by the formation of lattice-shaped electrical conductor patterns on the upper surface of the lower electrode sheet 110. The electrically conductive region 128 interconnects the electrically conductive regions 52-1 and 52-2. The electrically conductive region 128 interconnects the electrically conductive regions 52-2 and 52-3. The electrically conductive region 128 interconnects the electrically conductive regions 52-3 and 52-4. The electrically conductive region 128 extends from the electrically conductive regions 52-1 toward an edge of the lower electrode sheet 110. Each of the electrically conductive regions 128 is formed by the formation of lattice-shaped electrical conductor patters (not shown) on the upper surface of the lower electrode sheet 110.

As seen from a comparison between FIGS. 5A and 5B, the electrical conductor patters on the upper electrode sheet 70 and the electrical conductor patters on the lower electrode sheet 110 are formed in a direction in which the former electrical conductor patterns intersect the latter electrical conductor patterns. As seen from FIGS. 5A to 5C, the spacer 100 has the apertures 102 formed at respective regions corresponding with locations of: the pair of electrically conductive regions 48-1 and 52-1; the pair of electrically conductive regions 48-2 and 52-2; the pair of electrically conductive regions 48-3 and 52-3; the pair of electrically conductive regions 48-4 and 52-4.

Referring back to FIG. 4, each of the fabric sheets 54-1 to 54-4 is sewed onto the fabric sheet 180 so as to cover a corresponding one of the pads 56-1 to 56-4. In the sewing, each of the pads 56-1 to 56-4 is positioned below a corresponding one of the stepping regions 46-1 to 46-4. The pads 56-1 to 56-4 are thus secured in between the fabric sheet 54-1 to 54-4 and the fabric sheet 180, thereby forming a pad layer 310.

Referring to FIG. 1, the bottom sheet 190, the pad layer 310, the switch layer 300, the shock-absorbing sheet 60, and the top sheet 42 thus laminated together are rimmed with a piece of fabric tape 30, and are then sewed together by a string 44. In this way, the mat 40 is provided. The fabric tape 30 can be, e.g., bias tape.

Accordingly, when a game player treads on the stepping region 46-1, then the spacer 100 is compressed, thereby bringing the electrically conductive region 48-1 on the upper electrode sheet 70 into contact with the electrically conductive region 52-1 on the lower electrode sheet 110 through the apertures 102. As a result, the foot switch FS1 is turned on. Other foot switches FS2 to FS4 has same mechanism as the foot switch FS1.

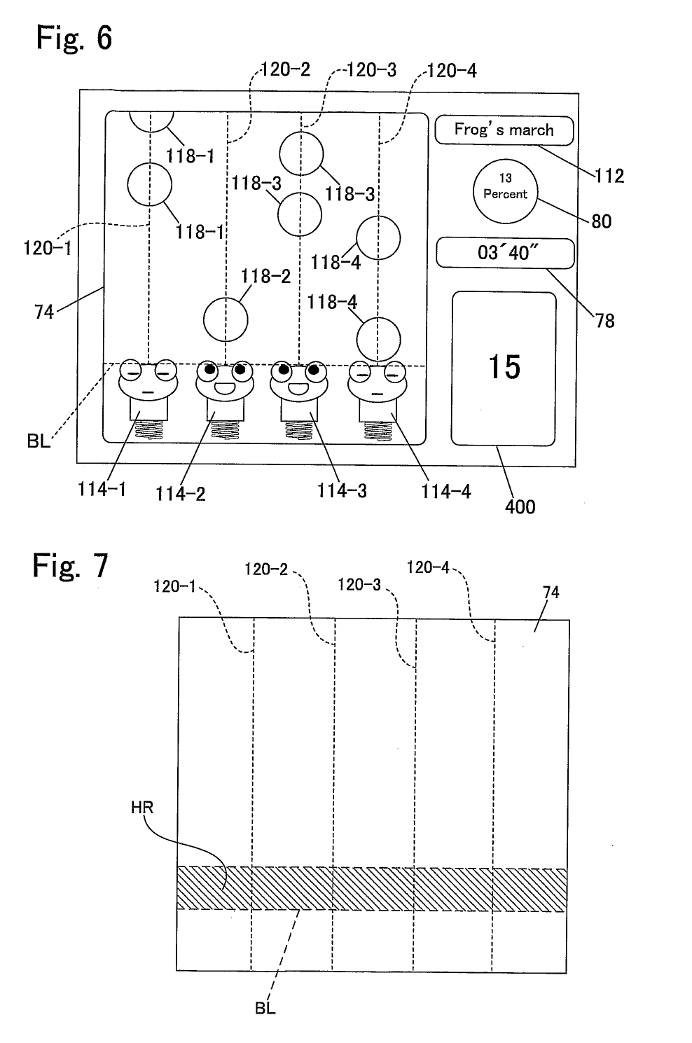

Next, a fitness mode in this present entertainment system is explained. FIG. 6 is a view showing an example of the play screen in the fitness mode. With starting the fitness play in the fitness mode, music is output from speakers (not shown) of the television monitor 1, and the game screen as shown in FIG. 6 is displayed on the television monitor 1. This play screen includes a main window 74, a music title display area 112 showing a title of music which is currently being played, a progress display area 80 indicating the current percentage of progress of music which is being played, an elapsed time display area 78 showing an elapsed time since the start of playing music, a failure time indicating area 400 displaying a number of moving objects 118-1 to 118-4 which a player failed to hit i.e. a number of times which the player failed to hit.

The main window 74 also includes response objects 114-1 to 114-4 corresponding to the stepping regions 46-1 to 46-4.

In the following description, the term “response object 114-J” (J=1 to 4) is generally used to represent the response objects 114-1 to 114-4.

While the foot switch “FSJ” corresponding to the stepping region “46-J” which is being stomped on is being turned on, the corresponding response object 114-J becomes different form from the one displayed when the foot switch “FSJ” is turned off.

A single or several circular moving object(s) 118-1 is/are displayed on a motion lane 120-1 corresponding to the response object 114-1 in the main window 74. On a motion lane 120-2 corresponding to the response object 114-2, a single or several circular moving object(s) 118-2 is/are displayed. On a motion lane 120-3 corresponding to the response object 114-3, a single or several circular moving object(s) 118-3 is/are displayed. On a motion lane 120-4 corresponding to the response object 114-4, a single or several circular moving object(s) 118-4 is/are displayed. Incidentally, the motion lines 120-1 to 120-4 are drawn by dashed lines in the figure for the sake of clarity in explanation. However, these lines are not actually displayed on the screen.

In the following description, the term “moving object 118-J” (J=1 to 4) is generally used to represent the moving objects 118-1 to 118-4. Also, the term “motion lane 120-J” (J=1 to 4) is generally used to represent the motion lanes 120-1 to 120-4.

The moving object “118-J” appears from the top edge of the corresponding motion lane “120-J” and descends to the bottom at prescribed acceleration. In this case, the interval between appearances of the moving object “118-J” is set to the interval in rhythm to the music. Incidentally, the initial speed of each moving object “118-J” is common and the acceleration of each moving object “118-J” is also common.

In the example of FIG. 6, the stepping regions 46-2 and 46-3 are stomped on, so the foot switches FS2 and FS3 is turned on. On the other hand, since the stepping regions 46-1 to 46-4 are not stomped on, the foot switches FS1 and FS4 are not turned off. Therefore, the form (the eyes of characters are opened) of the response objects 114-2 and 114-3 corresponding to the stepping regions 46-2 and 46-3 and the form (the eyes of characters are closed) of the response objects 114-1 and 114-4 corresponding to the stepping regions 46-1 and 46-4 are different. Because of this, the player can easily recognize the stepping region 46-2 and 46-3 which the player is stomping on without looking at own steps.

In addition, when the foot switch “FSJ” is turned on because the corresponding to stepping region “46-J” is stomped, the corresponding response object “114-J” displaces upward. After the response object “114-J” reaches a prescribed position, it returns to the original position.

If the moving object “118-J” exists within a hit range “HR” illustrated in FIG. 7 (more specifically, the bottom edge of the moving object “118-J” exists within the hit range “HR”) when the response object “114-J” displaces upward (i.e. the stepping region “46-J” is stomped on and the corresponding foot switch “FSJ” is turned on), a prescribed sound (referred as “stepping sound” in the following description) is output from the television monitor 1 and the moving object “118-J” existing within the hit range “HR” moves upwardly along the corresponding motion lane “120-J” (i.e. hit back) and then disappears at the top edge of the main window 74.

On the other hand, after the moving object “118-J” passes through the hit range “HR” (more specifically, the bottom edge of the moving object “118-J” passes a base line “BL”), even if the response object “114-J” displaces upward (i.e. the corresponding stepping region “46-J” is stomped on and the foot switch “FSJ” is turned on), the response object “114-J” can not hit the moving object “118-J”, therefore the moving object “118-J” disappears (i.e. failure). A count value indicating a number of failures displayed in the failure time indicating area 400 is counted up in response to the failure.

Incidentally, the interval between appearances of the moving object “118-J” is set to the interval in rhythm to the music. In addition, the timing of appearance of the moving object “118-J” is set to match the stepping sound output when the moving object “118-J” is hit by the response object “114-J” and the rhythm of the music at the timing when the moving object “118-J” enters to the hit range “HR” (more specifically, the bottom edge of the moving object “118-J” reaches the base line “BL”).

Therefore, the stepping sound is output at the right timing in rhythm to the music by stomping on the stepping region “46-J” to make the response object “114-J” displace (i.e. turn the foot switch “FSJ” on) while the moving object “118-J” exists in the hit range “HR”. Therefore, the player can comfortably perform stepping operation.

As explained above, the player can exercise in rhythm to the music by stepping in accordance with the moving object “118-J”. In other words, the player can enjoy exercising by stepping in rhythm to the music. Therefore, it is possible to support the player to continue exercising which people tend to fall by the wayside. Incidentally, the base line “BL” is drawn by a dashed line for the sake of clarity in explanation. Therefore, it is not actually displayed on the television monitor 1.

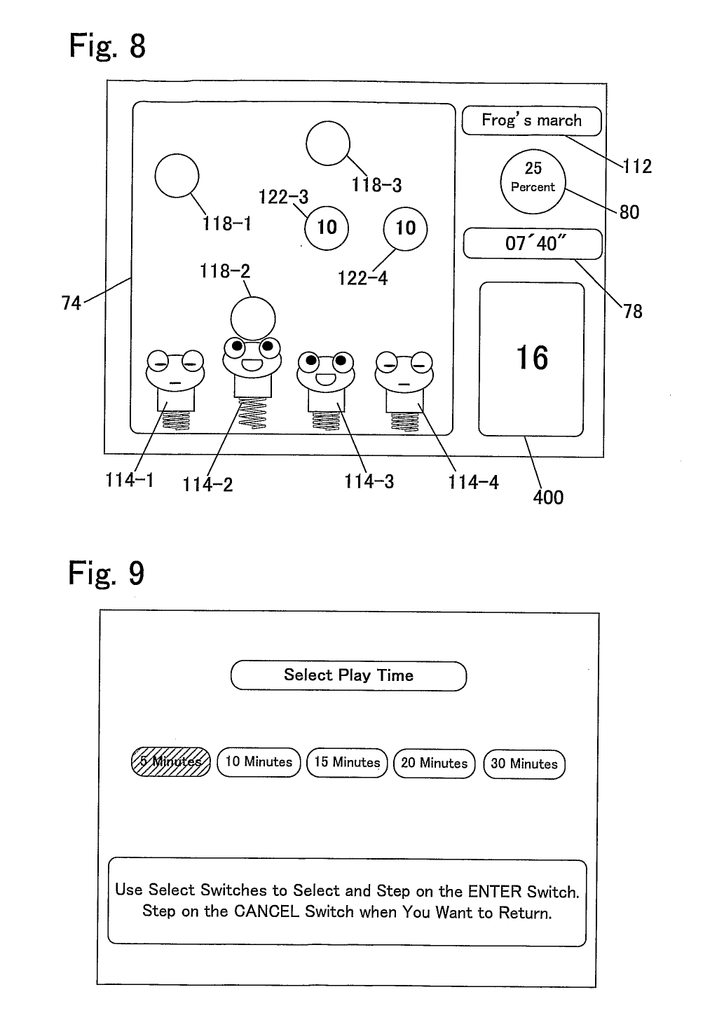

FIG. 8 is a view showing other example of the play screen in the fitness mode in accordance with the present embodiment. The play screen shown in FIG. 8 is a screen which is displayed just after the stepping region 46-2 is stomped on and the foot switch FS2 is turned on. As illustrated in FIG. 8, the response object 114-2 is moved in response to turning the corresponding foot switch FS2 on. In this way, the response object “114-J” is moved in response to turning the corresponding foot switch “FSJ” on. Incidentally, in the example of FIG. 8, since the stepping region 46-3 is still being stomped, the foot switch FS3 keeps the state of “on”.

When the moving objects 122-3 and 122-4 reaches the corresponding response objects 114-3 and 114-4, they stay at the positions for a predetermined period. The numbers inside the moving objects 122-3 and 122-4 indicate a number of times (10 times in this example) the player has to stomp on the corresponding stepping regions 46-3 and 46-4. In this case, the player has to stomp on the stepping regions 46-3 and 46-4 at least total ten times (i.e. the foot switches FS3 and FS4 have to be turned on and off at lease total ten times) while the moving objects 122-3 and 122-4 are staying at the positions. If the player fails to do this, it is regarded as failure. Therefore, the count value in failure time indicating area 400 will be counted up by 2. In this example, the moving objects “122-J” which instruct the player to stomp a number of times as the numbers inside the moving objects “122-J” within a predetermined period such as the moving objects 122-3 and 122-4 appears on the motion lanes 120-3 and 120-4. However, this kind of moving object “122-J” can be appeared on any motion lane, and the number can be any number.

In this embodiment, the term “moving object 122-J” (J=1 to 4) is generally used to represent the moving objects 122-1 to 122-4.

During the time (play time) as set before starting to play, a plurality of music pieces are played in order which is dynamically determined and appearance process of the moving objects 118-J and 122-J is performed. Then, when the preset play time is over, the ending screen is displayed on the television monitor 1.

FIG. 9 is a view showing an example of the play time setting screen of the fitness mode in accordance with the present embodiment. As illustrated in FIG. 9, before starting to play, the setting screen to set play time is displayed on the television monitor 1. In this example, the play time can be set to 5, 10, 15, or 30 minutes. The player can select the play time by stomping on the select switch 46-2 (foot switch FS2) or 46-3 (foot switch FS3). In FIG. 9, the selected play time (5 minutes) is showed with hatching. After selecting the play time, the player stomps on the decision switch 46-4 (foot switch FS4) to decide the selection. Then, the play screen is displayed during the selected play time.

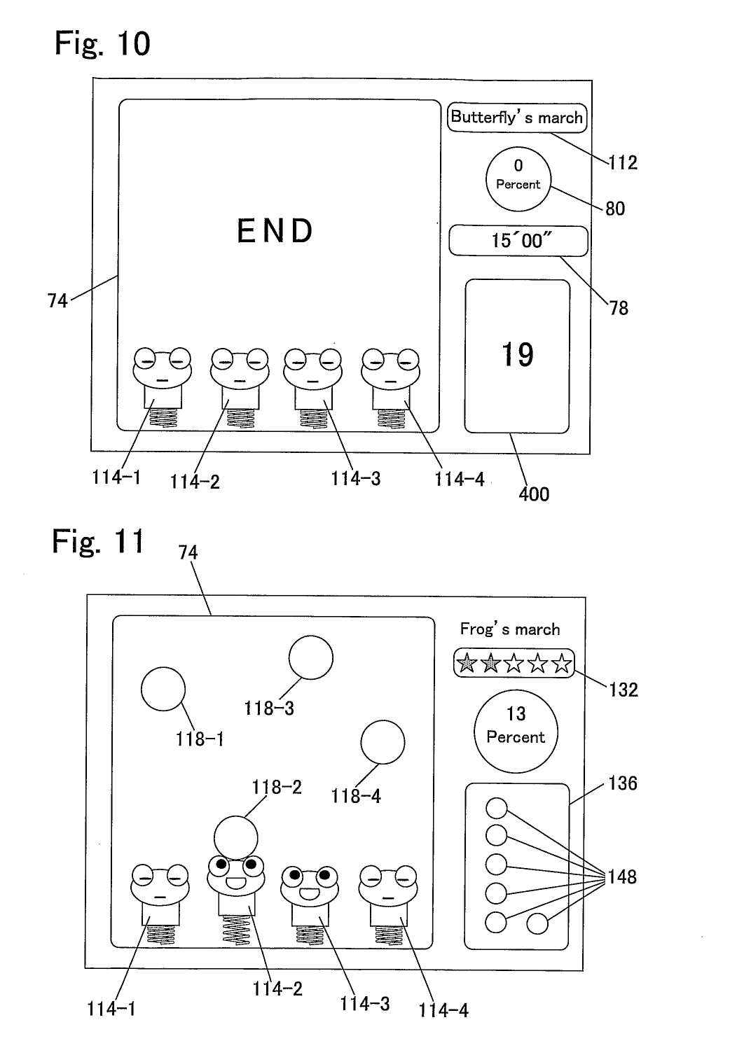

FIG. 10 is a view showing an example of ending screen of the fitness mode in accordance with the present embodiment. As illustrated in FIG. 10, the ending screen is displayed to inform the player the end after the selected play time is over. In this ending screen, for example, the word “END” may be displayed. In addition, display of the moving objects 118-J and 122-J is finished.

In this example, the word “END” is displayed to inform the player the end of play. However, it is not always necessary to display words to inform the end directly to the player. It can be done by finishing the music, extinguishing the moving objects 118-J and 122-J, extinguishing the response objects 114-J or combination thereof as long as it directly or indirectly informs the player the end of play. In addition, it is also possible to indirectly inform the player the end by making the response objects 114-J unable to operate even though they are being displayed.

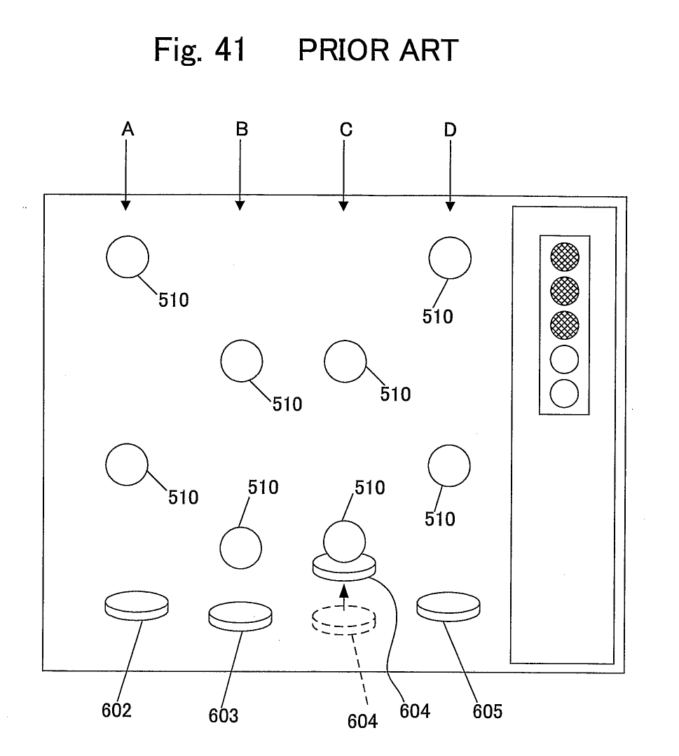

Next, a game mode will be explained. FIG. 11 is a view showing an example of play screen of the game mode in accordance with the present embodiment. In the game mode, if the player fails to hit the moving object 118-J, one of the life objects 148 in the life display area 136 will be extinguished. When all life objects 148 are consumed, the game is over. In addition, a difficulty level display area 132 is displayed to indicate the difficulty level of the game in the play screen. As has been discussed above, the contents of the game mode are similar to the game contents of the ball paddle game of FIG. 41.

By the way, for example, the player stays on the mat 40 and stomps on the stepping regions “46-J”

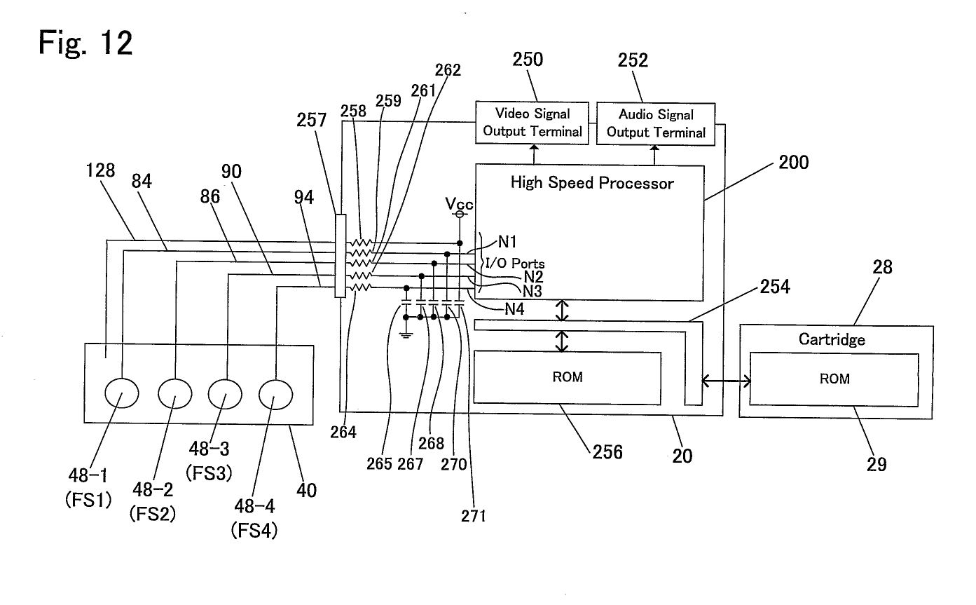

FIG. 12 is a view showing the electrical construction of the information processing apparatus 20 as illustrated in FIG. 1. As shown in FIG. 12, the information processing apparatus 20 includes a high speed processor 200, a ROM (read only memory) 256, a bus 254, a connector 257, a video signal output terminal 250 and an audio signal output terminal 252.

The high speed processor 200 is connected to the bus 254. Furthermore, the ROM 256 and 29 is connected to the bus 254. Therefore, the high speed processor 200 can access the ROM 256 and 29 through the bus 254 to read and execute the control program as stored in the ROM 256 or 29, and read and process the image data and the music data as stored in the ROM 256 or 29, and then generate a video signal and an audio signal and output them to the video signal output terminal 250 and the audio signal output terminal 252. As a result, the play screen (refer to FIGS. 6, 8 to 11) is displayed on the television monitor 1. In addition, the television monitor 1 outputs the music and sound effects through speakers (not shown).

The ROM 29 is built in the cartridge 28. The cartridge 28 is inserted into a slot (not shown) of the information processing apparatus 20 and connected to the bus 254. Accordingly, the player can enjoy games and fitness with many kinds of music by changing the cartridge 28.

The electrically conductive region 128 of the mat 40 is connected to a resistor element 258 at one end thereof through the connector 257. The other end of the resistor element 258 is connected to both a power supply “Vcc” and one end of a capacitor 271. The other end of the capacitor 271 is grounded.

The electrically conductive region 48-1 of the mat 40 is connected to a resistor element 259 at one end thereof through the connector 257. The other end (node “N1”) of the resistor element 259 is connected to both an input/output port “1” of the high-speed processor 200 and one end of a capacitor 270. The other end of the capacitor 270 is grounded. The electrically conductive region 48-2 of the mat 40 is connected linked to a resistor element 261 at one end thereof through the connect or 257. The other end (node “N2”) of the resistor element 261 is connected to both an input/output port “2” of the high-speed processor 200 and one end of a capacitor 268. The other end of the capacitor 268 is grounded.

The electrically conductive region 48-3 of the mat 40 is connected to a resistor element 262 at one end thereof through the connector 257. The other end (node “N3”) of the resistor element 262 is connected to both an input/output port “3” of the high-speed processor 200 and one end of a capacitor 267. The other end of the capacitor 267 is grounded. The electrically conductive region 48-4 of the mat 40 is connected to a resistor element 264 at one end thereof through the connector 257. The other end (node “N4”) of the resistor element 264 is connected to both an input/output port “4” of the high-speed processor 200 and one end of a capacitor 265. The other end of the capacitor 265 is grounded.

Respective lines connected to the nodes “N1” to “N4” are pulled down inside the high-speed processor 200.

As a result, the electrically conductive regions 52-1 to 52-4 on the lower electrode sheet 110 are supplied with power voltage “Vcc” through the resistor element 258. The electrically conductive regions 48-1 to 48-4 on the upper electrode sheet 70 are pulled down through the nodes “N1” to “N4”. As a result, when the game player tramps on the stepping region 46-1, then the electrically conductive regions 52-1 and 48-1 are forced into contact with one another to permit an electrical current to flow therethrough. This means that the foot switch FS1 corresponding with the stepping region 46-1 is switched on. Similarly, when the game player treads on each of the stepping regions 48-2 to 48-4, then a corresponding one of the foot switches FS2 to FS4 is turned on.

When the foot switch “FSJ” is thus turned on (i.e. stomped on), a corresponding one of the nodes “N1” to “N4” is brought to a high level. On the other hand, when the foot switch “FSJ” is turned off (i.e. not stomped on), a corresponding one of nodes N1 to N4 is brought to a low level.

When the player treads on the mat 40 in accordance with the play screen displayed on the television monitor 1, then the foot switch “FSJ” corresponding to the stepping region “46-J” trodden by the player is turned on. The high-speed processor 200 executes control program-ordered information processing in response to ON-OFF information from each of the foot switches “FSJ” of the mat 40.

In the following description, the term “input/output (I/O) port J” (J=1 to 4) is generally used to represent the input/output (I/O) ports “1” to “4”.

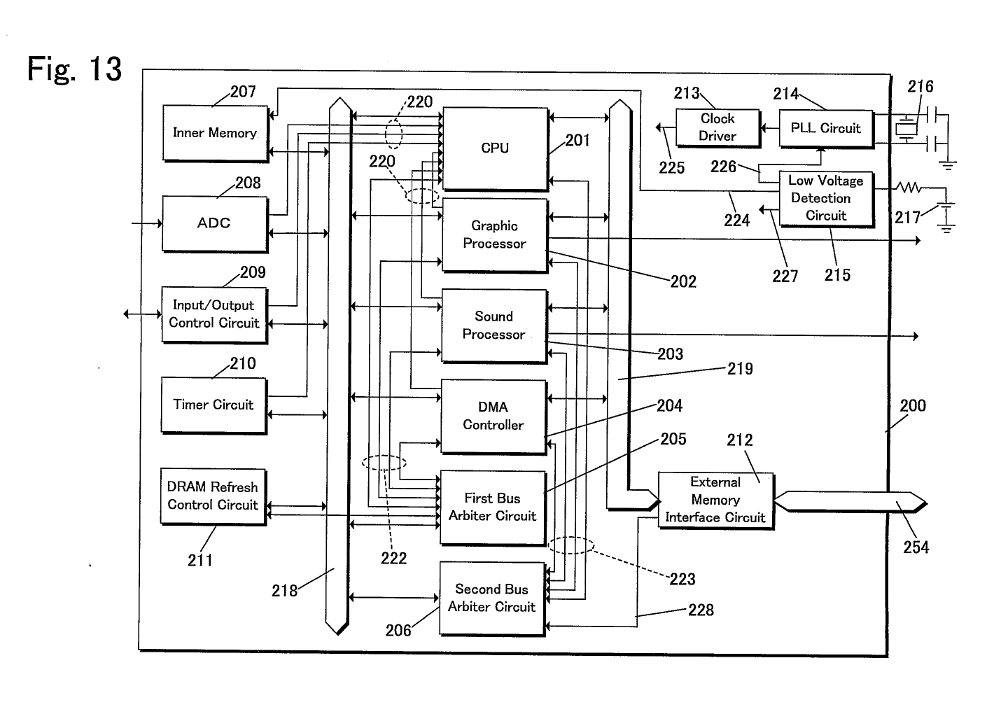

As shown in FIG. 13, this processor 200 includes a CPU (central processing unit) 201, a graphic processor 202, a sound processor 203, a DMA (direct memory access) controller 204, a first bus arbitrator circuit 205, a second bus arbitrator circuit 206, an inner memory 207, an A/D converter (ADC: analog to digital converter) 208, an input and output control circuit 209, a timer circuit 210, a DRAM (dynamic random access memory) refresh control circuit 211, an external memory interface circuit 212, a clock driver 213, a PLL (phase-locked loop) circuit 214, a low voltage detector circuit 215, a first bus 218 and a second bus 219.

The CPU 201 takes control of the entire system and performs various types of arithmetic operations in accordance with the control program stored in the memory (the inner memory 207, the ROM 256, or the ROM 29). The CPU 201 is a bus master of the first bus 218 and the second bus 219, and can access the resources connected to the respective buses.

The graphic processor 202 is also a bus master of the first bus 218 and the second bus 219, and generates the video signal on the basis of the data as stored in the memory (the inner memory 207, the ROM 256 or the ROM 29), and output the video signal (composite signal in the case of this embodiment) through the video signal output terminal 250. The graphic processor 202 is controlled by the CPU 201 through the first bus 218. Also, the graphic processor 202 has the functionality of outputting an interrupt request signal 220 to the CPU 201.

The sound processor 203 is also a bus master of the first bus 218 and the second bus 219, and generates the audio signal on the basis of the data as stored in the memory (the inner memory 207, the ROM 256 or the ROM 29), and output the audio signal through the audio signal output terminal 252. The sound processor 203 is controlled by the CPU 201 through the first bus 218. Also, the sound processor 203 has the functionality of outputting an interrupt request signal 220 to the CPU 201.

The DMA controller 204 serves to transfer data from the ROM 256 or the ROM 29 to the inner memory 207. Also, the DMA controller 204 has the functionality of outputting, to the CPU 201, an interrupt request signal 220 indicative of the completion of the data transfer. The DMA controller 204 is also a bus master of the first bus 218 and the second bus 219. The DMA controller 204 is controlled by the CPU 201 through the first bus 218.

The inner memory 207 may be implemented with one or any necessary combination of a mask ROM, an SRAM (static random access memory) and a DRAM in accordance with the system requirements. A battery 217 is provided if the SRAM has to be powered by the battery for maintaining the data contained therein. In the case where the DRAM is used, the so called refresh cycle is periodically performed to maintain the data contained therein.

The first bus arbiter circuit 205 accepts a first bus use request signal from the respective bus masters of the first bus 218, performs bus arbitration among the requests for the first bus 218, and issue a first bus use permission signal to one of the respective bus masters. Each bus master is permitted to access the first bus 218 after receiving the first bus use permission signal. In FIG. 13, the first bus use request signal and the first bus use permission signal are illustrated as the first bus arbitration signal 222.

The second bus arbiter circuit 206 accepts a second bus use request signal from the respective bus masters of the second bus 219, performs bus arbitration among the requests for the second bus 219, and issue a second bus use permission signal to one of the respective bus masters. Each bus master is permitted to access the second bus 219 after receiving the second bus use permission signal. In FIG. 13, the second bus use request signal and the second bus use permission signal are illustrated as the second bus arbitration signal 223.

The input and output control circuit 209 serves to perform input and output operations of input/output signals to enable the communication with external input/output device(s) and/or external semiconductor device(s). The read and write operations of input/output signals are performed by the CPU 201 through the first bus 218. Also, the input and output control circuit 209 has the functionality of outputting an interrupt request signal 220 to the CPU 201.

The input and output control circuit 209 is connected with the input/output ports “0” to “15”, and receives ON/OFF-signals from the mat 40 through the input/output ports “1” to “4”.

The timer circuit 210 has the functionality of periodically outputting an interrupt request signal 220 to the CPU 201 with a time interval as preset. The setting of the timer circuit 210 such as the time interval is performed by the CPU 201 through the first bus 218.

The ADC 208 converts analog input signals into digital signals. The digital signals are read by the CPU 201 through the first bus 218. Also, the ADC 208 has the functionality of outputting an interrupt request signal 220 to the CPU 201.

The PLL circuit 214 generates a high frequency clock signal by multiplication of the sinusoidal signal as obtained from a crystal oscillator 216.

The clock driver 213 amplifies the high frequency clock signal as received from the PLL circuit 214 to a sufficient signal level to supply the respective blocks with the clock signal 225.

The low voltage detection circuit 215 monitors the power potential Vcc and issues the reset signal 226 of the PLL circuit 214 and the reset signal 227 to the other circuit elements of the entire system when the power potential Vcc falls below a certain voltage. Also, in the case where the inner memory 207 is implemented with the SRAM requiring the power supply from the battery 217 for maintaining data, the low voltage detection circuit 215 serves to issue a battery backup control signal 224 when the power potential Vcc falls below the certain voltage.

The external memory interface circuit 212 has the functionality of connecting the second bus 219 to the bus 254 and issuing a bus cycle completion signal 228 of the second bus 219 to control the length of the bus cycle of the second bus 219.

The DRAM refresh cycle control circuit 211 periodically and unconditionally gets the ownership of the first bus 218 to perform the refresh cycle of the DRAM at a certain interval. Needless to say, the DRAM refresh cycle control circuit 211 is provided in the case where the inner memory 207 includes the DRAM.

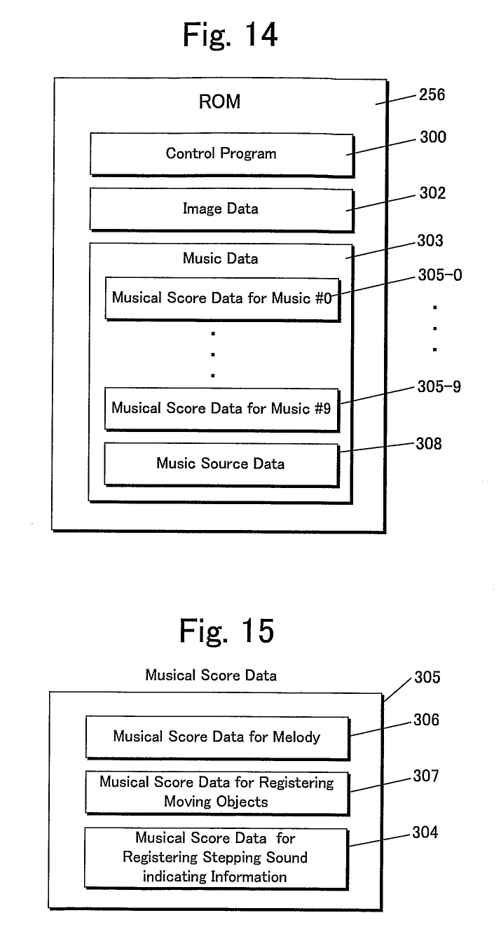

FIG. 14 is a schematic representation of the control program and the data stored in the ROM 256 of FIG. 12. As illustrated in FIG. 14, the ROM 256 stores a control program 300, image data 302, and music data 303. The music data 303 includes musical score data 305-0 to 305-9 for music number “0” to “9” and sound source data 308.

In the following description, the term “musical score data 305” is generally used to represent the musical score data 305-0 to 305-9.

Alternatively, the program and the data stored in the ROM 256 may stored in the ROM 29 of the memory cartridge 28 which is inserted into the slot (not shown) of the information processing apparatus 20 to make use of the program and the data.

FIG. 15 is a schematic representation of an example of the musical score data 305 of FIG. 14. As illustrated in FIG. 15, the musical score data 305 includes musical score data 306 for melody, musical score data 307 for registering moving objects, and musical score data 304 for registering stepping sound indicating information.

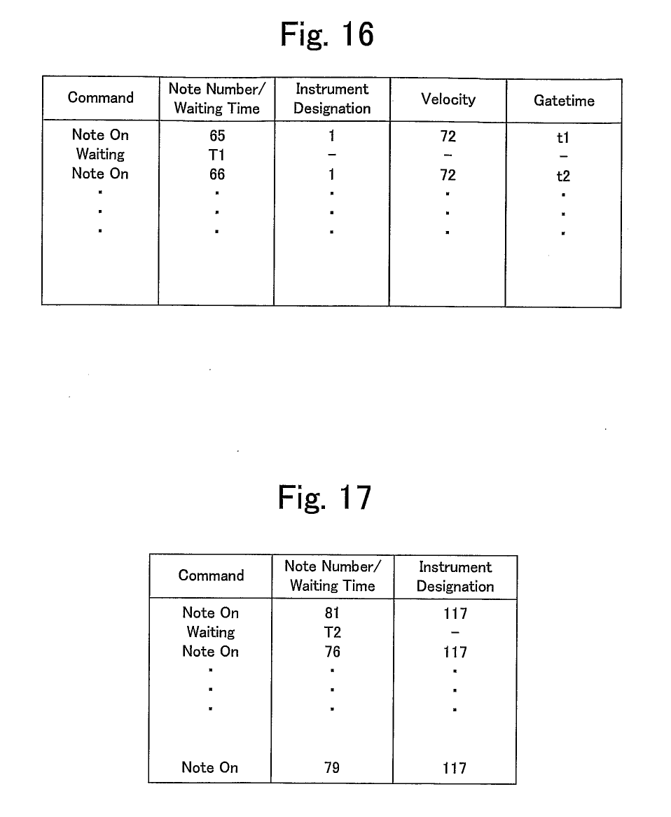

The musical score data 306 for melody is data containing melody control information arranged in a time series. FIG. 16 is a schematic representation of an example of the musical score data 306 for melody of FIG. 15. As illustrated in FIG. 16, the melody control information contains command information, note number/waiting time information, instrument designation information, velocity information, and gate time information.

In the figure, “Note On” is a command to output a sound, and “Wait” is a command to set a waiting time. The waiting time is the time period to elapse prior to reading the next command after reading the current command (the time period between one musical note and the next musical note). The note number information designates a pitch (the frequency of sound vibration). The waiting time information designates the waiting time. The instrument designation information designates a musical instrument whose tone quality is to be used. The velocity information designates a magnitude of sounds, i.e., a sound volume. The gate time information designates a period for which the output of a sound is continued.

Returning to FIG. 15, the musical score data 307 for registering moving objects is data containing moving object control information arranged in a time series. Then, the musical score data 307 for registering moving objects is used to display the moving objects 118-J and 122-J in the main window 74. In other words, while the musical score data 306 for melody is musical score data to play music, the musical score data 307 for registering moving objects is musical score data to have the moving objects 118-J and 122-J appear at correct intervals in synchronization with the music.

FIG. 17 is a schematic representation of an example of the musical score data 307 for registering moving objects of FIG. 15. As shown in FIG. 17, the moving object control information contains command information, note number/waiting time information, and instrument designation information.

In the musical score data 307 for registering moving objects, the instrument designation information does not designate the instrument number corresponding to the instrument (tone quality) of which a sound is to be output. Namely, in the musical score data 307 for registering moving objects, the instrument designation information designates the number corresponding to the instrument which makes the moving objects 118-J and 122-J appear. It is indicated by the instrument designation information that the musical score data 307 for registering moving objects is not musical score data for playing music but musical score data for letting the moving objects 118-J and 122-J be displayed.

Accordingly, “Note On” in this case is not a command to output a sound but a command to let the moving objects 118-J or 122-J be displayed. Also, the note number is not the information which designates a pitch (the frequency of sound vibration) but the information indicating which moving object is displayed and which motion lane is used. This point will be explained in detail.

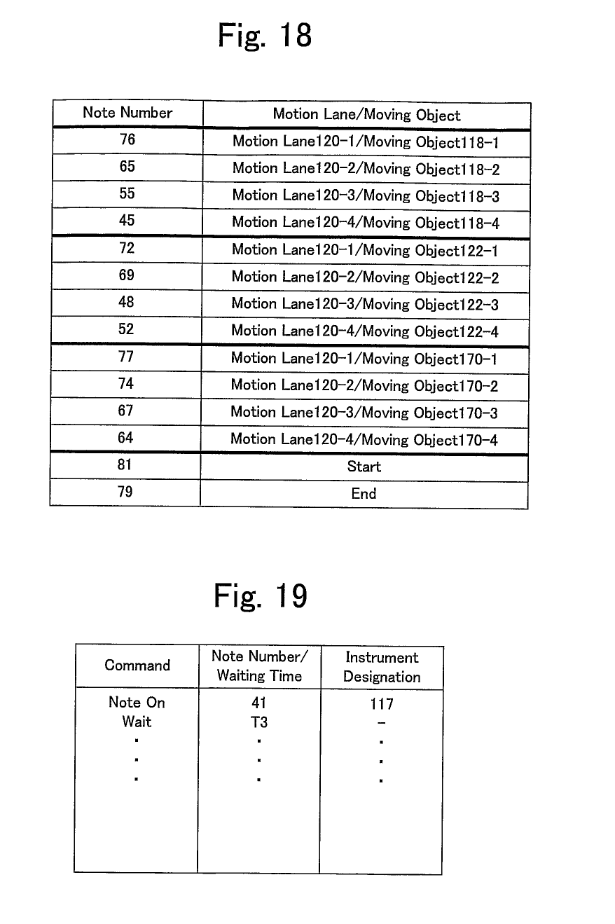

FIG. 18 is a view showing the relation between the note numbers used in the musical score data 307 for registering moving objects of FIG. 17, the moving objects and the motion lanes. As shown in FIG. 18, for example, the note number “76” designates that the moving object 118-1 is displayed on the motion lane 120-1 of the main window 74. Also, for example, the note number “72” designates that the moving object 122-1 indicative of 10-times successive stepping within a certain period is displayed on the motion lane 120-1 of the main window 74. Also, for example, the note number “77” designates that the moving object 170-1 indicative of 20-times successive stepping within a certain period is displayed on the motion lane 120-1 of the main window 74.

On the other hand, for example, the note number “81” is a dummy data item which is placed at the head of the musical score data 307 for registering moving objects (refer to FIG. 17) but not the information indicating which moving object is displayed and which motion lane is used. In this configuration, the head of the musical score data 306 is aligned with the head of the musical score data 307. Furthermore, for example, the note number “79” is a data item which is placed at the tail end of the musical score data 307 for registering moving objects to indicate the end of music (refer to FIG. 17). Meanwhile, the note number “79” is not the information indicating which moving object is displayed and which motion lane is used.

Returning to FIG. 15, the musical score data 304 for registering stepping sound indicating information is data containing stepping sound control information arranged in a time series. FIG. 19 is a schematic representation of an example of the musical score data 304 for registering stepping sound indicating information of FIG. 15. As shown in FIG. 19, the stepping sound control information contains command information, note number/waiting time information, and instrument designation information.

The musical score data 304 for registering stepping sound indicating information is not the instrument number corresponding to the instrument (tone quality) of which sound is to be output. The instrument designation information is a number indicating that the musical score data 304 for registering stepping sound indicating information is musical score data for deciding the stepping sound to be output in response to the stomp on the stepping region 46-J.

Accordingly, “Note On” in this case is not a command to output a sound but a command designating the stepping sound to be output in response to the stomp on the stepping region 46-J. Also, the note number is not the information which designates a pitch (the frequency of sound vibration) but the stepping sound indicating information (the information indicating the stepping sound). The stepping sound indicating information will be explained in detail.

The latest stepping sound indicating information item (note number) read from the musical score data 304 for registering stepping sound indicating information is registered. Then, a waveform data start address (a start address of waveform data) associated with the stepping sound indicating information as registered is read from the ROM 256 or 29 and stored in the inner memory 207. In this case, a stepping sound setting table stored in the ROM 256 or 29 is referred to.

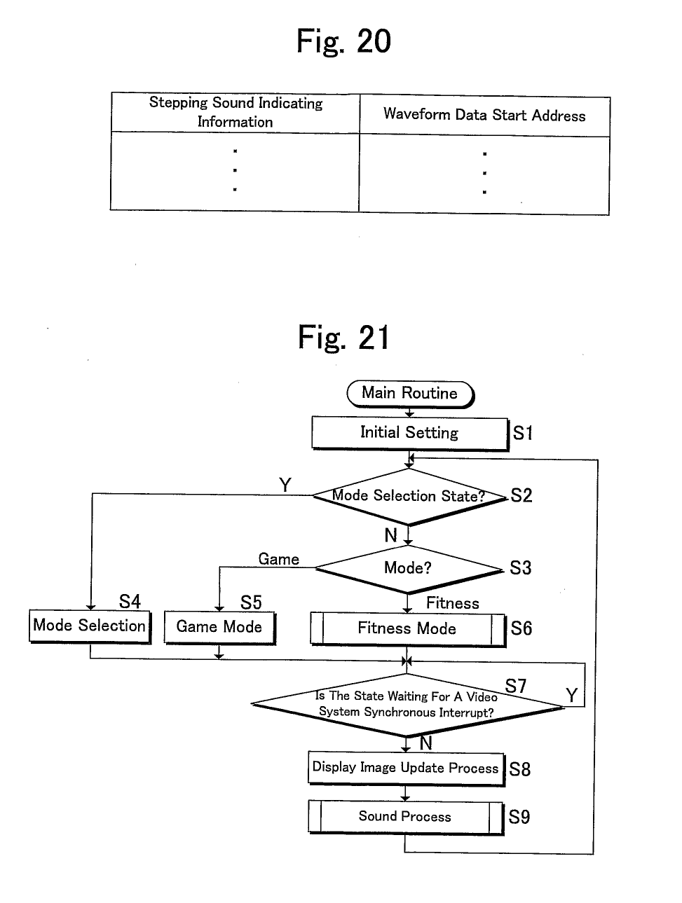

FIG. 20 is a view showing an example of the stepping sound setting table stored in the ROM 256 or 29 of FIG. 12. As shown in FIG. 20, the stepping sound setting table is a table in which the stepping sound indicating information and the waveform data start addresses are associated with each other. The waveform data start address associated with the stepping sound indicating information as registered can be acquired by referring to this stepping sound setting table.

When the stepping region 46-J is trodden on, the sound processor 203 reads the waveform data start address associated with the stepping sound indicating information as registered. Then the sound processor 203 reads the waveform data stored in the location pointed by the waveform data start address from the ROM 256 or 29, and generates the audio signal corresponding to the waveform data and outputs the audio signal to the audio signal output terminal 252. In this configuration, the stepping sound corresponding to the waveform data read from the ROM 256 or 29 is output through the speakers (not shown in the figure) of the television monitor 1. Incidentally, the waveform data is contained in the sound source data 308 of FIG. 14.

FIG. 21 is a flowchart showing the overall process flow of the information processing apparatus 20 of FIG. 1. As shown in FIG. 21, the CPU 201 performs the initial setup of the system in step S1. In step S2, the CPU 201 determines whether or not the current state is a mode selection state. If the current state is the mode selection state, the CPU 201 proceeds to step S4, otherwise proceeds to step S3. In step S4, the CPU 201 enters the fitness mode or the game mode in accordance to the information input by the player.

In step S3, the CPU 201 checks the current mode. If the current mode is the game mode, the CPU 201 proceeds to step S5 and performs processing for the game mode (refer to FIG. 11). If the current mode is the fitness mode, the CPU 201 proceeds to step S6 and performs processing for the fitness mode (refer to FIGS. 6 and 8 to 10).

In step S7, the CPU 201 determines whether or not the CPU 201 waits for a video system synchronous interrupt. If the CPU 201 waits for the video system synchronous interrupt (there is no interrupt responsive to a video system synchronous signal), the process repeats the same step S7. On the other hand, if the CPU 201 gets out of the state of waiting for the video system synchronous interrupt (i.e., the CPU 201 is given the video system synchronous interrupt), the process proceeds to step S8.

In step S8, in response to the instruction from the CPU 201, the graphic processor 202 reads image data from the ROM 256 or 29 and updates the display image displayed on the television monitor 1 on the basis of the information (storage location information of image data and display coordinates information) set in step S4, S5 or S6. In step S9, the sound processor 203 generates the audio signal in accordance with the instruction from the CPU 201. In this way, the display image update process of step S8 and the audio process of step S9 are performed in synchronization with the video system synchronous interrupt.

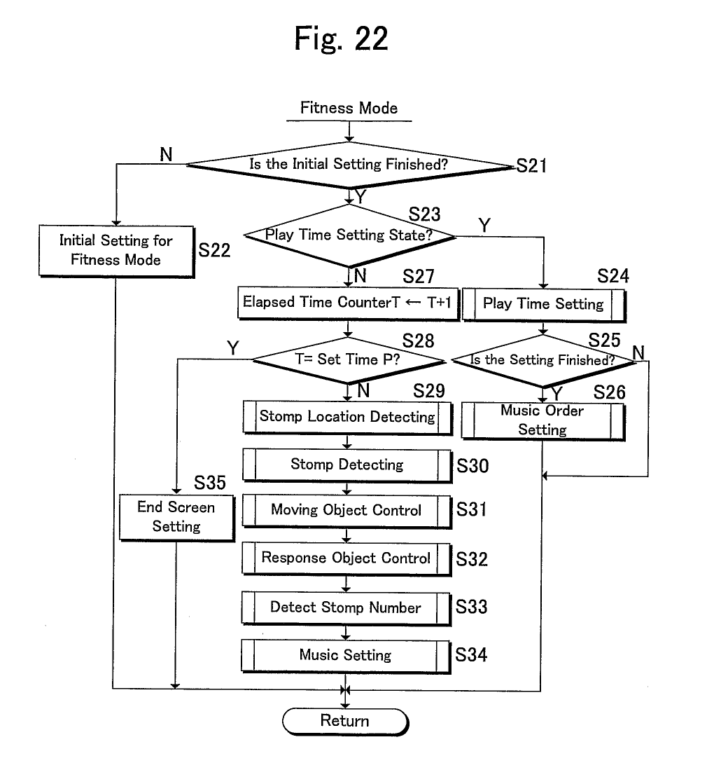

FIG. 22 is a flowchart showing the process flow of the fitness mode in step S6 of FIG. 21. As illustrated in FIG. 22, the CPU 201 determines whether or not the initial setup of the fitness mode is finished. If it is not finished, the CPU 201 proceeds to step S22 and performs the initial setup of the fitness mode, otherwise proceeds to step S23. In step S22, the CPU 201 performs fitness-mode-specific initializing process such as initializing various flags and counters. Incidentally, a music end flag, to be described below, is turned on.

In step S23, the CPU 201 determines whether or not the current state is the play time selection state. If the current state is the play time selection state, the CPU 201 proceeds to step S24, otherwise proceeds to step S27. In step S24, the CPU 201 sets play time “P” in accordance with information input by the player. In step S25, the CPU 201 determines whether or not the setting of the play time “P” is finished. If the setting is finished, the CPU 201 proceeds to step S26, otherwise return to the main routine. In step S26, the CPU 201 sets the order of music to be played back, and then returns to the main routine.

In step S27, the CPU 201 increments an elapsed time counter “T”. Incidentally, this counter “T” is initialized to “0” in step S22. In step S28, the CPU 201 determines whether or not the elapsed time counter “T” reaches the play time “P” which is set in step S24. Namely, the CPU 201 determines whether or not the play time “P” as set has elapsed. If the play time “T” elapses, the CPU 201 proceeds to step S35, otherwise proceeds to step S29. In step S35, the CPU 201 sets necessary information, to the internal memory 207, for displaying the end screen (refer to FIG. 10). The necessary information for displaying the end screen includes storage location information image data indicating a background and each object constituting the end screen and display coordinates information.

In step S29, the CPU 201 detects the foot switch or foot switches which is/are turned on out of four foot switches FS1 to FS4. In step S30, the CPU 201 compares current on/off information of each foot switch FS1 to FS4 with previous one, and detects the foot switch or switches which transits from off to on.

In step S31, the CPU 201 controls motion of the moving objects “118-J” and “122-J”. In step S32, the CPU 201 controls motion of the response object “114-J”. In addition, in step S32, the CPU 201 controls for changing form of the response object(s) “114-J” corresponding to the foot switch(es) “FSJ” which is (are) currently turned on.

In step S33, the CPU 201 detects a number of times the foot switches “FSJ” are turned on and off while the moving objects “122-J” reach and stay at the response objects “114-J”. As explained above, the moving objects “122-J” instruct to step consecutively a predetermined number of times within a predetermined period. In step S34, the CPU 201 sets music to be played back, and then returns to the main routine.

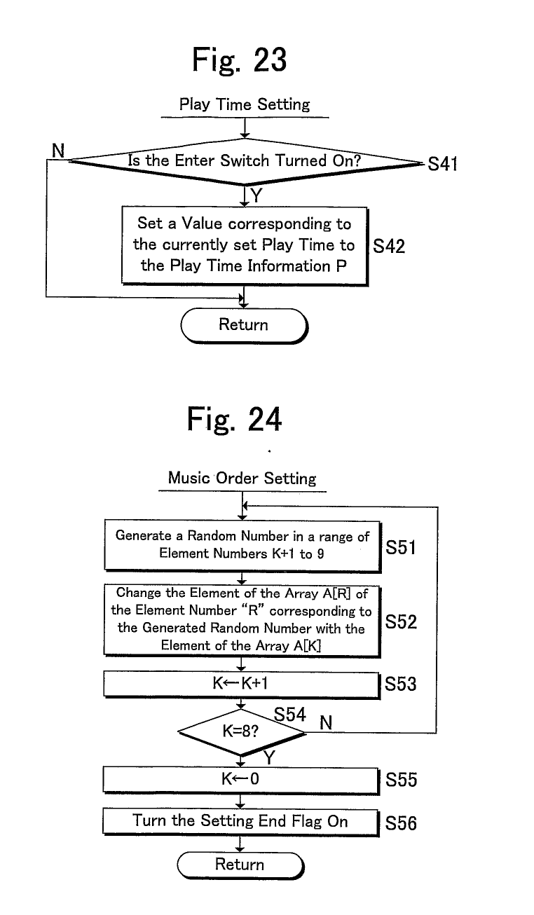

FIG. 23 is a flowchart showing the process flow of play time setting in step S24 of FIG. 22. As illustrated in FIG. 23, the CPU 201 judges whether or not the foot switch FS4 as the decision switch (corresponding to the stepping region 46-4 of FIG. 2) is turned on in accordance with a value of the I/O port “4”. If the foot switch FS4 is turned on, the CPU 201 proceeds to step S42, otherwise returns to the routine of FIG. 22. In step S42, the CPU 201 sets a value corresponding to the play time selected in the play time selection screen of FIG. 9 to the play time information “P”, and then returns to the routine of FIG. 22.

FIG. 24 is a flowchart showing the process flow of the music order setting in step S26 of FIG. 22. As illustrated in FIG. 24, the CPU 201 generates a random number in a range of element numbers K+1 to 9 of an array “A” in step S51. In this embodiment, since ten kinds of music are provided (refer to FIG. 14), the array “A” has ten elements. Therefore, relevant music numbers are assigned to the array A[0] to A[9].

In step S52, the CPU 201 changes the element (music number) of the array A[R] of the element number “R” which is same as the random number generated in step S51 with the element (music number) of the array A[K]. In other words, the CPU 201 assigns the element of the array A[R] to the array A[K], and the element of the array A[K] to the array A[R]

In step S53, the CPU 201 increments the counter “K”. In step S54, the CPU 201 judges whether or not the counter “K” has become “8”. If the counter “K” has not become “8”, the CPU 201 proceeds to step S51, otherwise proceeds to step S55. In step S55, the CPU 201 sets “0” to the counter “K”. In step S56, the CPU 201 turns on the setting end flag indicative of completion of setting the order of the music, and returns to the routine of FIG. 22.

As has been discussed above, the order of the music to be played back can be dynamically set by repeating the processes between step S51 and S53 (by generating random numbers and shuffling the elements (music numbers) of the array A[0] to A[9]).

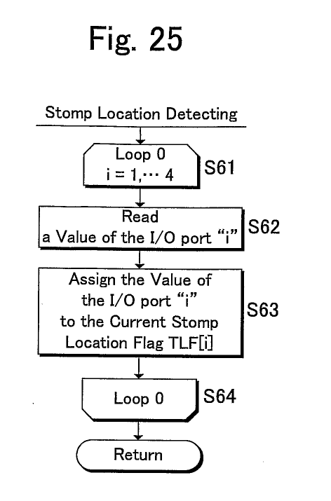

FIG. 25 is a flowchart showing the process flow of the stepping location detecting process in step S29 of FIG. 22. As illustrated in FIG. 25, in this stepping location detecting process, the processes between step S61 and step S64 are repeated while updating variable “i” from i=1 to i=4, and then returns to the routine of FIG. 22.

In step S62, the CPU 201 reads a value of the I/O port “i”. In step S63, the CPU 201 assigns the value of the I/O port “i” to a stomp location flag TLF[i] (referred as “current stomp location flag TLF[i]” in following description) indicating the foot switch FS“i” which is currently turned on (stomped on).

As explained above, since on(1)/off(0) information of the foot switches FS1 to FS4 is set to the I/O ports “1” to “4”, it is possible to recognize which of foot switches FS1 to FS4 is/are currently turned on in accordance with the values of the I/O port “1” to “4”. Therefore, the CPU 201 can recognize which of foot switches FS1 to FS4 is/are currently turned on with reference to the current stomp location flag TLF[1] to TLF[4].

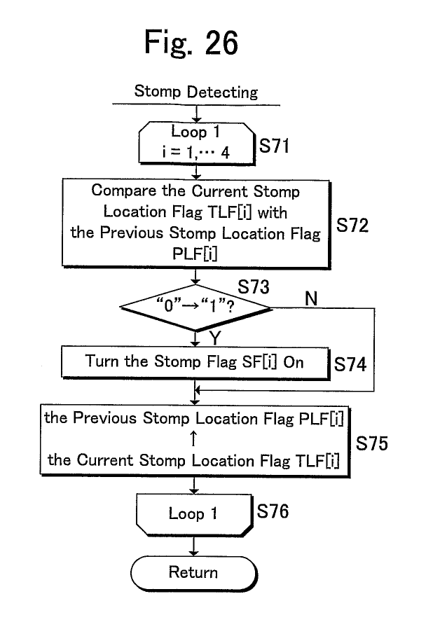

FIG. 26 is a flowchart showing the process flow of a stepping detecting process in step S30 of FIG. 22. As illustrated in FIG. 26, in this stepping detecting process, the processes between step S71 and step S76 are repeated while updating variable “i” from i=1 to i=4, and then returns to the routine of FIG. 22.

In step S72, the CPU 201 compares the current stomp location flag TLF[i] with the stomp location flag PLF [i] (referred as “previous stomp location flag PLF[i]” in following description) indicative of the foot switch FS“i” which was previously turned on (stomped on).

Then, if the previous stomp location flag PLF[i] is “0” (i.e. the foot switch FS“i” was turned off previous time) and also the current stomp location flag TLF[i] is “1” (i.e. the foot switch FS“i” is turned on this time), the CPU 201 proceeds to step S74, otherwise proceeds to step S75.

In step S74, the CPU 201 turns the stepping flag SF[i] on. In step S75, the CPU 201 assigns a value of the current stomp location flag TLF[i] to the previous stomp location flag PLF[i].

As explained above, in this stepping detecting process, the CPU 201 detects the moment when the foot switch “FSJ” is turned on (i.e. the foot switch “FSJ” is stomped on).

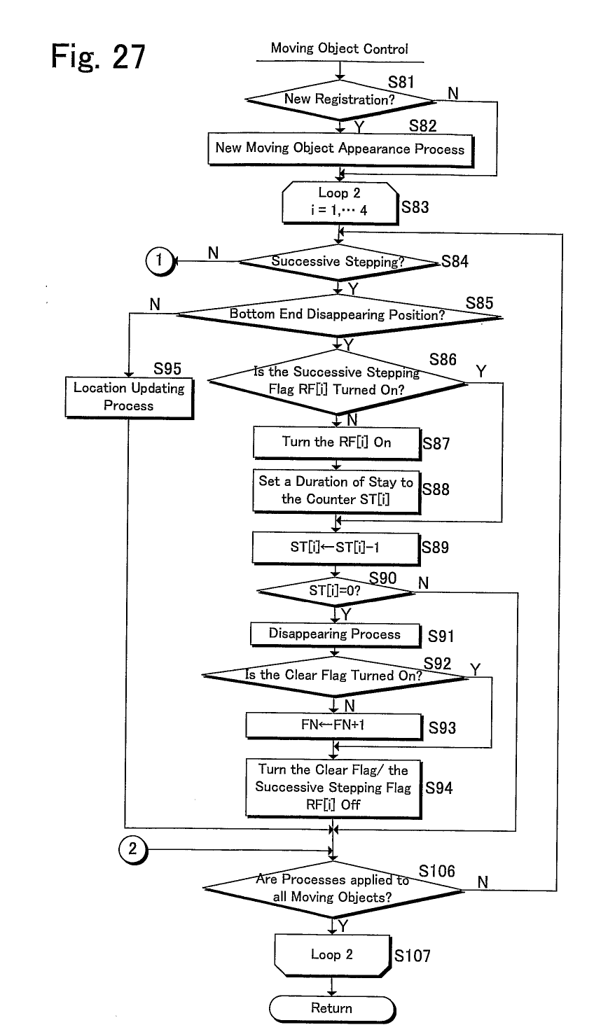

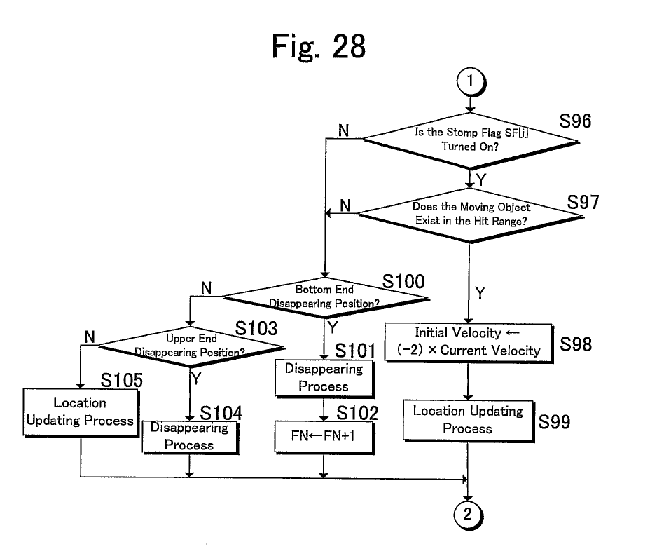

FIG. 27 is a flowchart showing the process flow of the moving object control in step S31 of FIG. 22. FIG. 28 is a flowchart showing the process flow of the process which is performed after “No” is judged in step S84 of FIG. 27.

As illustrated in FIG. 27, in step S81, the CPU 201 checks if the moving objects “118-J” and “122-J” are newly registered. If the moving object(s) has/have been newly registered, the CPU 201 proceeds to step S82, otherwise proceeds to step S83.

In step S82, the CPU 201 performs the appearance process of the moving object(s) which is/are newly registered. More specifically, the CPU 201 sets display coordinates and storage location information of image data indicating the moving object to the internal memory 207.

Then, the CPU 201 repeats the process between step S83 and step S107 while updating the variable “i” from “1” to “4” in the moving object control process. In other words, the processes between step S83 and step S107 are applied to all motion lanes 120-1 to 120-4.

In step S84, the CPU 201 judges whether or not the moving object existing on the motion lane 120-“i” is the moving object 122-“i”. If it is the moving object 122-“i”, the CPU 201 proceeds to step S85, otherwise (if it is the moving object 118-“i”) proceeds to step S96.

In step S85, the CPU 201 judges whether or not the moving object 122-“i” reaches the disappearing position (the base line “BL”) at the bottom of the main window 74. If the moving object 122-“i” has reached the position, the CPU 201 proceeds to step S86, otherwise proceeds to step S95. In step S95, the CPU 201 performs process for updating the location of the moving object 122-“i”. More specifically, the CPU 201 calculates display coordinates of the moving object 122-“i” on the basis of the predetermined initial velocity and acceleration, and set them to the inner memory 207.

Incidentally, when the moving object 122-“i” reaches the disappearing position at the bottom of the main window 74, it means the start of the instruction to step consecutively the predetermined number of times within the predetermined period.

In step S86, the CPU 201 checks the on/off information of a successive stepping flag RF[i]. If it is “on”, the CPU 201 proceeds to step S89, otherwise proceeds to step S87. The successive stepping flag RF[i] indicates whether or not there currently is an instruction to step consecutively the predetermined number of times within the predetermined period. In other words, when the successive stepping flag RF[i] is still turned off, the CPU 201 proceeds to step S87 to turn it on. If the successive stepping flag RF[i] is already turned on, there is no need to turn it on, therefore the CPU proceeds to step S89.

In step S87, the CPU 201 turns the successive stepping flag RF[i] on. In step S88, the CPU 201 sets duration of stay of the moving object 122-“i” to a counter ST[i]. This duration of stay designates the period which the moving object 122-“i” stays at the disappearing position at the bottom of the main window 74 (i.e. the player has to finish stepping successively for prescribed times during this period).

In step S89, the CPU 201 decrements the counter ST[i]. In step S90, the CPU 201 determines whether or not the counter ST[i] has become “0”. If the counter ST[i] has already become “0”, the CPU 201 proceeds to step S91, otherwise proceeds to step S106. In step S91, the CPU 201 performs the extinguishing process of the moving object 122-“i”. More specifically, the display coordinates of the moving object 122-“i” are set to be located outside of the television monitor 1.

In step S92, the CPU 201 checks on/off information of a clear flag “CF”. If it is turned on, the CPU 201 proceeds step S94, otherwise proceeds to step S93. The Clear flag “CF” indicates whether or not consecutive stepping for the predetermined number of times within the predetermined period have been performed. In step S93, the CPU 201 increments a failure counter “FN” which counts a number of times the player fails to hit the moving objects. In step S94, the CPU 201 turns the clear flag “CF” and the successive stepping flag RF[i] off.

In step S96 of FIG. 28, the CPU 201 judges whether or not the stepping flag SF[i] is turned on. If it is turned on, the CPU 201 proceeds to step S97, otherwise proceeds to step S100. In step S97, the CPU 201 determines whether or not the moving object 118-“i” is in the hit range “HR”. If the moving object 118-“i” is in the hit range “HR”, the CPU 201 proceeds to step S98, otherwise proceeds to step S100.

In step S98, the CPU 201 sets (−) twice of the current velocity to the initial velocity of the moving object 118-“i”. In step S99, the CPU 201 calculates display coordinates of the moving object 118-“i” on the basis of the initial velocity as set in step S98, and sets to the inner memory 207. In this way, the moving object 118-“i” is hit upwardly at twice velocity.

In step S100, the CPU 201 determines whether or not the moving object 118-“i” has reached the disappearing position (the base line “BL”) at the bottom of the main window 74. If the moving object 118-“i” has reached, the CPU 201 proceeds to step S101, otherwise proceeds to step S103. In step S101, the CPU 201 performs the extinguishing process of the moving object 118-“i”. More specifically, the display coordinates of the moving object 118-i are set to be located outside of the television monitor 1. In this way, the moving object 118-“i” which the player failed to hit vanishes at the bottom edge of the main window 74. Then, the CPU 201 increments the failure counter “FN” in step S102.

On the other hand, in step S103, the CPU 201 determines whether or not the moving object 118-“i” has reached a disappearing position at the upper edge of the main window 74. If the moving object 118-“i” has reached the disappearing position, the CPU 201 proceeds to step S104, otherwise (i.e. the moving object 118-“i” still exists on the motion lane 120-“i”) proceeds to step S105. In step S104, the CPU 201 performs the extinguishing process of the moving object 118-“i”. More specifically, the display coordinates of each sprite constituting the moving object 118-i are considered to be coordinates outside of the television monitor 1. In this way, the moving object 118-“i” which was hit vanishes at the upper edge of the main window 74.

In step S105, the CPU 201 performs process for updating the location of the moving object 118-“i”. More specifically, the CPU 201 calculates display coordinates of the moving object 118-“i” on the basis of the current initial velocity and the acceleration, and then sets them in the inner memory 207. Therefore, the moving object 118-“i” moves upward or downward in accordance with the current initial velocity.

Returning to FIG. 27, in step S106, the CPU 201 determines whether or not the processes between step S84 and step S105 have been applied to all moving objects 118-“i” and 122-“i” existing on the motion lane 120-“i”. If they have not been applied yet, the CPU 201 proceeds to step S84, otherwise proceeds to step S107.

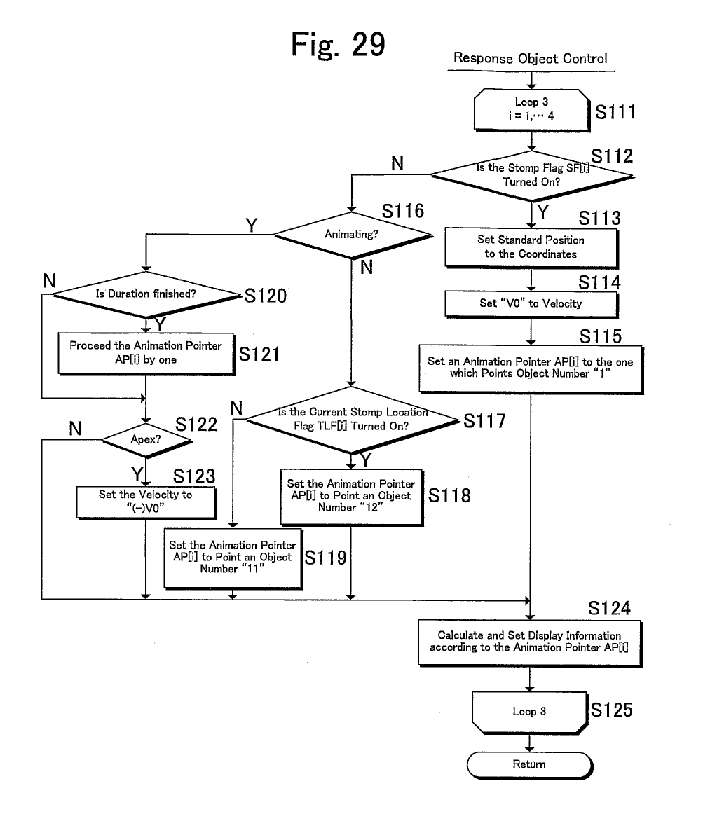

FIG. 29 is a flowchart showing the process flow of the response object control in step S32 of FIG. 22. As illustrated in FIG. 29, the processes from step S111 to step S125 are repeatedly performed while updating the variable “i” from “1” to “4”. After that the CPU 201 returns to the routine of FIG. 22.

In step S112, the CPU 201 judges whether or not the stepping flag ST[i] is turned on. If the stepping flag ST[i] is turned on, the CPU 201 proceeds to step S113, otherwise proceeds to step S116. In step S113, the CPU 201 sets standard position to display coordinates of the response object 114-“i”. In step S114, the CPU 201 sets velocity of the response object 114-“i” to a predetermined value “V0”. Therefore, when the stepping flag SF[i] is turned on, the response object 114-“i” is displaced at the velocity “V0”.

In step S115, the CPU 201 sets an animation pointer AP[i] to the one which points object number “1” of an animation table. The animation table is a table for animating the response object 114-“i” when the stepping flag SF[i] is turned on.

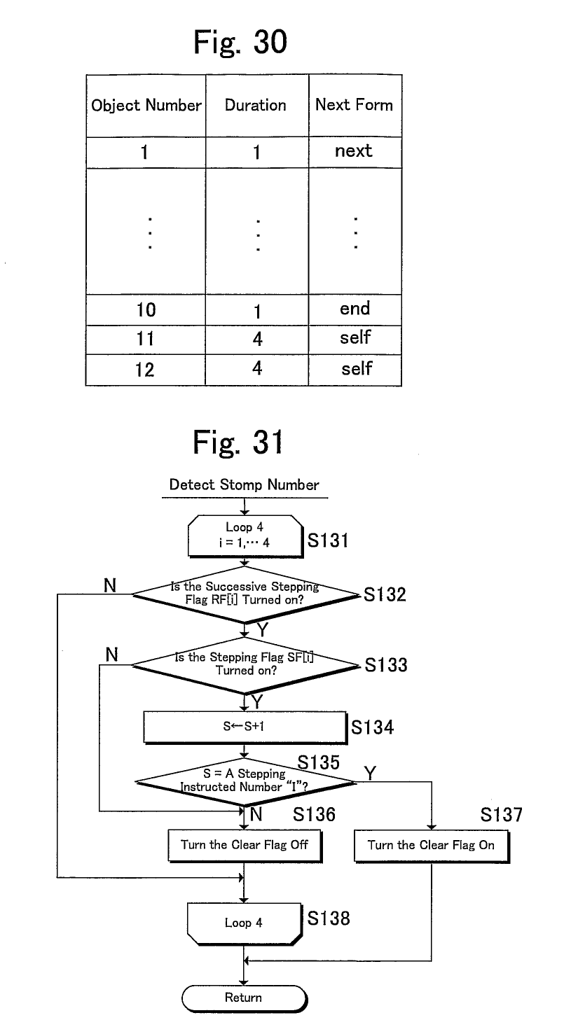

FIG. 30 is a view showing the animation table of the response object “114-J” in this present embodiment. As illustrated in FIG. 30, the animation table is a table in which object number information, duration information and next form information are associated with each other.

The object number is given to each different form of the response object “114-J”. The duration information designates a number of video frames the specified form of the response object “114-J” by the object number should be successively displayed. The next form information designates the object number which specifies the form of the response object “114-J” to be displayed after the specified form of the response object “114-J” is displayed in accordance with the duration information.

For example, the next form information “next” indicates to display specified form of the response object “114-J” by the object number “2” after displaying specified form of the response object “114-J” by the object number “1” during one video frame (the duration information). The next form information “end” indicates to finish animation after displaying specified form of the response object “114-J” by the object number “10” during one video frame (the duration information). The next form information “self” indicates to display the specified form of the response object 114-J by the same object number “11” again after displaying the specified form of the response object 114-J by the object number “11” during four video frames (the duration information). In this way, the static (not animated) response object “114-J” is displayed in the main window 74.

Incidentally, the object number “11” indicates the form (the response object 114-1 and 114-4 in FIG. 6) of the response object “114-J” which is displayed when the foot switch “FSJ” is turned off. The object number “12” indicates the form (the response object 114-2 and 114-3 in FIG. 6) of the response object “114-J” which is displayed when the foot switch “FSJ” is turned on.

Returning to FIG. 29, the CPU 201 judges whether or not the response object 114-“i” is being animated in step S116. If it is not being animated, the CPU 201 proceeds to step S117, otherwise proceeds to step S120.

In step S117, the CPU 201 judges whether or not the current stomp location flag TLF[i] is turned on. If it is turned on, the CPU 201 proceeds to step S118, otherwise proceeds to step S119. In step S118, the CPU 201 sets the animation pointer AP[i] to point the object number “12”. In addition, the CPU 201 sets display coordinate of the response object 114-“i” to the standard position and set velocity to “0”. In this way, the form (refer to the response object 114-2 and 114-3 in FIG. 6) of the response object 114-“i” which indicates the foot switch FS“i” is turned on (i.e. the stepping region 46-“i” is being stepped on) is displayed.

In step S119, the CPU 201 sets the animation pointer AP[i] to point the object number “11”. In addition, the CPU 201 sets display coordinates of the response object 114-“i” to the standard position and sets velocity to “0”. In this way, the form (refer to the response object 114-1 and 114-4 in FIG. 6) of the response object 114-“i” which indicates the foot switch FS“i” is turned off (i.e. the stepping region 46-“i” is not being stepped on) is displayed.

In step S120, the CPU 201 judged whether or not the duration is finished. If it is finished, the CPU 201 proceeds to step S121, otherwise proceeds to step S122. In step S121, the CPU 201 proceeds the animation pointer AP[i] by one.

In step S122, the CPU 201 judges whether or not the response object 114-“i” has reached an apex. If it has reached the apex, the CPU 201 proceeds to step S123, otherwise proceeds to step S124. Incidentally, the amount of displacement of the response object 114-“i” is predetermined distance. Therefore, when the response object 114-“i” displaces for the predetermined distance from the standard position, it is considered that the response object 114-“i” reaches the apex. In step S123, the CPU 201 sets the velocity to “(−)V0” in order to place back to the standard position.

In step S124, the CPU 201 sets storage location information of image data corresponding to the object number pointed by the animation pointer AP[i] to the inner memory 207. In addition, the CPU 201 calculates display coordinates of the response object 114-“i” on the basis of velocity information and sets them to the inner memory 207.

FIG. 31 is a flowchart showing the process flow of the stepping number detecting process in step S33 of FIG. 22. As illustrated in FIG. 31, in this process, the processes from step S131 to step S138 are repeatedly performed while updating the variable “i” from “1” to “4”, and then returns to the routine of FIG. 22.

In step S132, the CPU 201 judges whether or not the successive stepping flag RF[i] is turned on. If it is turned on, the CPU 201 proceeds to step S133, otherwise proceeds to step S138. In step S133, the CPU 201 judges whether or not the stepping flag SF[i] is turned on. If it is turned on, the CPU 201 proceeds to step S134, otherwise proceeds to step S136.

In step S134, the CPU 201 increments a counter “S” which counts a number of times of stepping. In step S135, the CPU 201 judges whether or not the counter “S” reaches a stepping instructed number “I”. If it reaches the stepping instructed number “I”, the CPU 201 proceeds to step S137 and turns the clear flag “CF” on, and then returns to the routine of FIG. 22. On the other hand, if it does not reach the stepping instructed number “I”, the CPU 201 proceeds to step S136 and turns the clear flag “CF” off, and then proceeds to step S138.

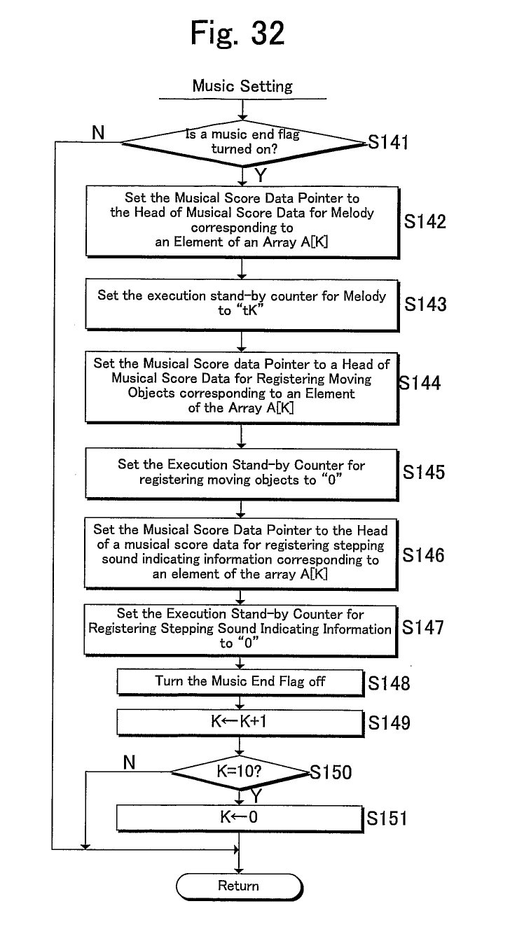

FIG. 32 is a flowchart showing the process flow of the music setting process in step S34 of FIG. 22. As illustrated in FIG. 32, the CPU 201 judges whether or not the music end flag is turned on in step S141. If it is turned off, the CPU 201 returns to the routine of FIG. 22, otherwise proceeds to step S142.

In step S142, the CPU 201 sets a musical score data pointer for melody to point at the start of the musical score data 306 for melody corresponding to the music number which is the element of the array A[K] (refer to step S26 of FIG. 22). This will be explained in detail.

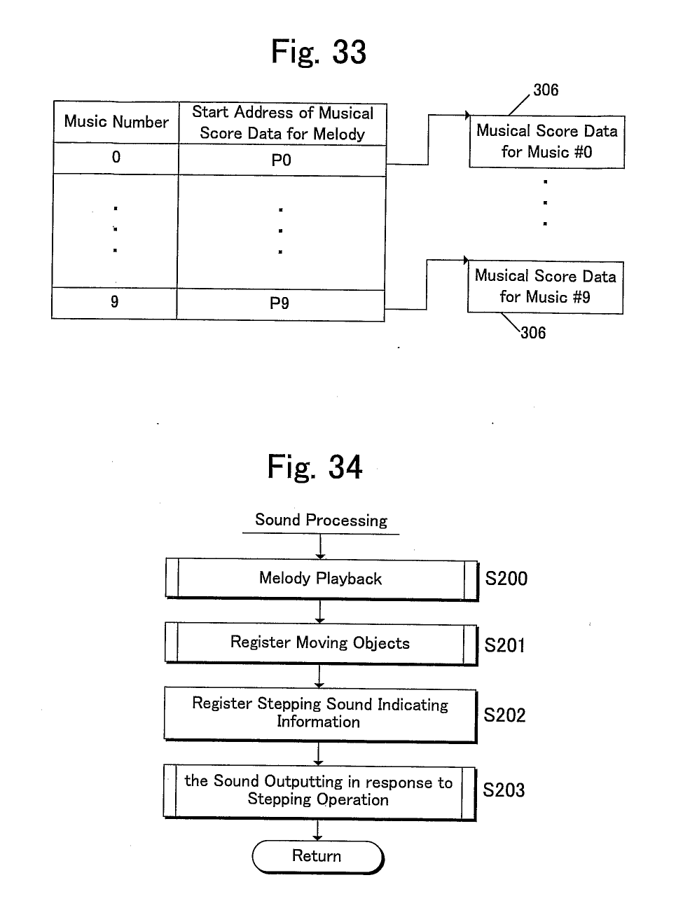

FIG. 33 is a view showing the relation among the music number, the start address of the musical score data for melody and the musical score data for melody. As illustrated in FIG. 33, the CPU 201 obtains the start address of the musical score data 306 for melody corresponding to the music number which is the element of the array A[K] with reference to the table where the music number and the start address of the musical score data are associated therewith, and sets it to the musical data pointer for melody. Then, this musical score data pointer for melody points a head of the musical score data 306 for melody corresponding to the music number which is the element of the array A[K].

Returning to FIG. 32, the CPU 201 sets an execution stand-by counter for melody to “tK” in step S143.

In step S144, the CPU 201 sets a musical score data pointer for registering the moving objects to point at the start of the musical score data 307 for registering the moving objects corresponding to the music number which is the element of the array A[K]. In step S145, the CPU 201 sets an execution stand-by counter for registering the moving objects to “0”.

In step S146, the CPU 201 sets a musical score data pointer for registering the stepping sound indicating information to point at the start of the musical score data 304 for registering the stepping sound indicating information corresponding to the music number which is the element of the array A[K]. In step S147, the CPU 201 sets an execution stand-by counter for registering the stepping sound indicating information to “0”.

In step S148, the CPU 201 turns the music end flag off. In step S149, the CPU 201 increments the counter “K”. In step S150, the CPU 201 judges whether or not the counter “K” becomes “10”. If it becomes “10”, the CPU 201 proceeds to step S151 and assigns “0” to the counter “K”, otherwise returns to the routine of FIG. 22.

Incidentally, the reason why the execution stand-by counter for melody is set to “tK” and the execution stand-by counter for registering the moving objects is set to “0” is as follows.

For example, as illustrated in FIG. 6, it takes a certain period for the moving object 118-1 to reach the base line “BL” after appearing from the upper edge of the motion lane 120-1 of the main window 74. Therefore, the moving object 118-1 must be displayed at the certain period earlier to compensate this differential time. In other words, the musical score data 307 for registering the moving objects is read out at the certain period (the counter value “tK”) earlier than the musical score data 306 for melody. Incidentally, the execution stand-by counter for registering the moving objects, the execution stand-by counter for melody and the execution stand-by counter for registering the stepping sound indicating information serve to count down.

FIG. 34 is a flowchart showing the process flow of the sound process in step S9 of FIG. 21. As illustrated in FIG. 34, the CPU 201 performs sound outputting process of melody in step S200. In step S201, the CPU 201 performs the registration process of the moving objects “118-J” and “122-J”. In step S202, the CPU 201 performs registration process of the stepping sound indicating information. In step S203, the CPU 201 performs the outputting process of the stepping sound in response to stepping operation (turning the foot switch “FSJ” on).

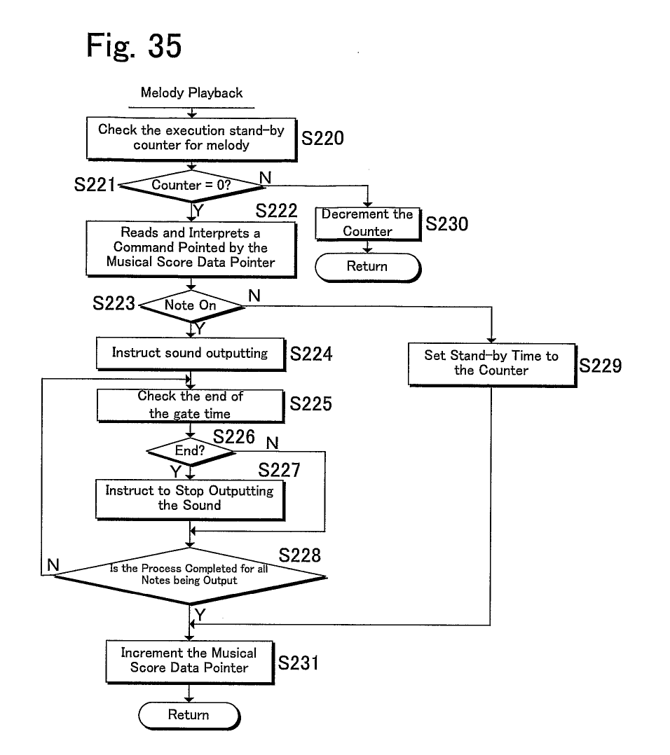

FIG. 35 is a flowchart showing the process flow of a melody playback in step S200 of FIG. 34. As illustrated in FIG. 35, the CPU 201 checks the execution stand-by counter for melody in step S220. If the execution stand-by counter for melody is “0”, the CPU 201 proceeds to step S222, otherwise proceeds to step S230 and decrements the execution stand-by counter, and then returns to the routine of FIG. 34.

In step S222, the CPU 201 reads and interprets a command pointed by the musical score data pointer for melody. If the command is “Note On”, the CPU 201 proceeds to step S224, otherwise (if it is “Stand-by”) the CPU 201 proceeds to step S231.

In step S224, the CPU 201 stores waveform pitch control information, start address information of waveform data, envelope pitch control information and start address information of envelope data in accordance with the note number and the instrument designation information pointed by the musical score data pointer for melody in the inner memory 207, and also stores the channel volume information corresponding to the velocity information and the gate time information in the inner memory 207. The CPU 201 instructs the sound processor 203 to access the inner memory 207. Then, the sound processor 203 reads the above information as stored in the inner memory 207 in the appropriate timing, and generates an audio signal.

The pitch control information for waveform data is used to perform the pitch conversion by changing the frequency of reading the waveform data. Namely, the sound processor 203 periodically reads the pitch control information every certain period and accumulates the pitch control information. The sound processor 203 processes the accumulation results, and then makes use of the result of processing as the address pointer of waveform data. Accordingly, if a large value is set as pitch control information, the address pointer is quickly incremented by the large value to increase the frequency of the waveform data. Conversely, if a small value is set as pitch control information, the address pointer is slowly incremented by the small value to decrease the frequency of the waveform data. In this way, the sound processor 203 performs the pitch conversion of the waveform data. The pitch information for the envelope data is similar to the pitch information for the waveform data. In step S225, the CPU 201 checks the remaining time of the gate time for the note. If the gate time elapses in step S226, the CPU 201 proceeds to step S227, instructs the sound processor 203 to stop outputting the sound corresponding to the note, and then proceeds step S228. On the other hand, if the gate time does not elapse in step S226, the process proceeds to step S228. In step S228, the CPU 201 determines whether or not the process in step S225 is completed for all notes being output, and if not completed, the process proceeds to step S225, otherwise proceeds to step S231.

In step S229, the CPU 201 sets stand-by time to the execution stand-by counter for melody. In step S231, the CPU 201 increments the musical score data pointer for melody and returns to the routine of FIG. 34.

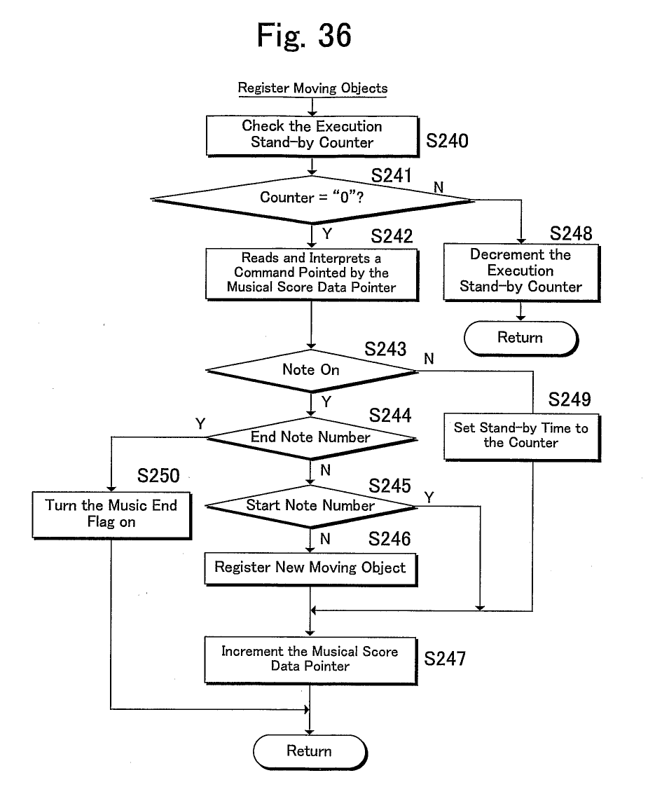

FIG. 36 is a flowchart showing the process flow of registering the moving objects in step S201 of FIG. 34. As illustrated in FIG. 36, the CPU 201 checks the execution stand-by counter for registering the moving objects in step S240. If the execution stand-by counter for registering the moving objects is “0”, the CPU 201 proceeds to step S242, otherwise proceeds to step S248 (step S241). In step S248, the CPU 201 decrements the execution stand-by counter for registering the moving objects and returns to the routine of FIG. 34.

In step S242, the CPU 201 reads and interprets a command pointed by the musical score data pointer for registering the moving objects. If the command is “Note On”, the CPU 201 proceeds to step S244 (step S243). On the other hand, the command is not “Note On” i.e. is “Stand-by”, the CPU 201 proceeds to step S249. In step S249, the CPU 201 sets stand-by time to the execution stand-by counter for registering the moving objects.

On the other hand, if the note number indicates the end of music, the process proceeds to step S250, otherwise proceeds to step S245 (step S244). In step S250, the CPU 201 turns the music end flag on.

On the other hand, if the note number indicates the start of music, the process proceeds to step S247, otherwise proceeds to step S246 (step S245). In step S246, the CPU 201 newly registers the moving object in accordance with the note number. In step S247, the CPU 201 increments the musical score data pointer for registering the moving objects and returns to the routine of FIG. 34.

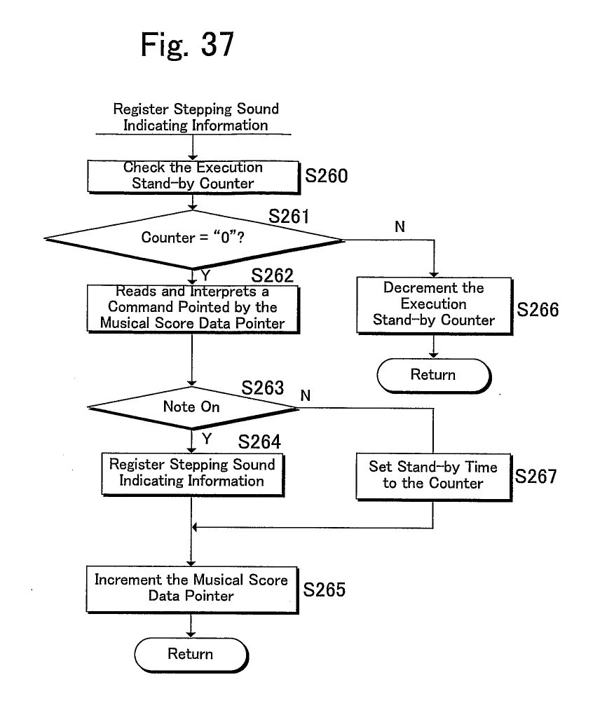

FIG. 37 is a flowchart showing the process flow of registering the stepping sound indicating information in step S202 of FIG. 34. As illustrated in FIG. 37, the CPU checks the execution stand-by counter for registering the stepping sound indicating information in step S260. If the execution stand-by counter for registering the stepping sound indicating information is “0”, the CPU 201 proceeds to step S262, otherwise proceeds to step S266 (step S261). In step S266, the CPU 201 decrements the execution stand-by counter for registering the stepping sound indicating information.

In step S262, the CPU 201 reads and interprets a command pointed by the musical score data pointer for registering the stepping sound indicating information. If the command is “Note On”, the CPU 201 proceeds to step S264 (step S263). On the other hand, the command is not “Note On” i.e. is “Stand-by”, the CPU 201 proceeds to step S267 (step S263). In step S267, the CPU 201 sets stand-by time to the execution stand-by counter for registering the stepping sound indicating information.

In step S264, the CPU 201 registers the stepping sound indicating information in accordance with the note number. In step S265, the CPU 201 increments the musical data pointer for registering the stepping sound indicating information and returns to the routine of FIG. 34.

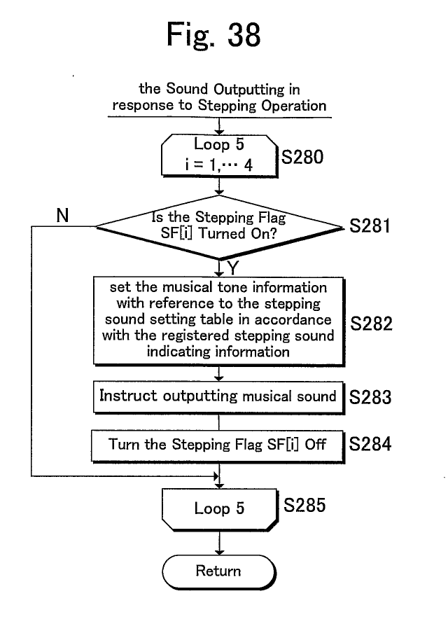

FIG. 38 is a flowchart showing the process flow of outputting sound in response to stepping operation in step S203 of FIG. 34. As illustrated in FIG. 38, in this process, the processes from step S280 to step S285 are repeatedly performed while updating the variable “i” from “1” to “4”, and then returns to the routine of FIG. 34.

In step S281, the CPU 201 judges whether or not the stepping flag SF[i] is turned on. If the stepping flag SF[i] is turned on, the CPU 201 proceeds to step S282, otherwise proceeds to step S285. In step S282, the CPU 201 obtains the musical tone information (or start address of waveform data) with reference to the stepping sound setting table (refer to FIG. 20) in accordance with the registered stepping sound indicating information, and sets it to the inner memory 207.

In step S283, the CPU 201 instructs the sound processor 203 to access the inner memory 207. Then sound processor 203 accesses the inner memory 207 and reads the waveform data start address as set in step S282 in the appropriate timing. The sound processor 203 obtains the waveform data from the ROM 256 or 29 in accordance with the start address, and generates an audio signal. In step S284, the CPU 201 turns the stepping flag SF[i] off.

As has been discussed above, in this embodiment, the player can set desired play time, and enjoy playing the game where the player steps on the foot switches “FSJ” to operate the response objects “114-J” trying to hit the moving objects “118-J” and “122-J” during the play time. In addition, the player can enjoy the stepping operation with music. In this way, the player can play monotonous stepping operation with enjoyment. Furthermore, the image of the response object “114-J” displayed when the foot switch “FSJ” is turned off is different from the image of the response object “114-J” displayed when the foot switch “FSJ” is turned on. Therefore, the player can easily recognize which foot switch(es) the player is/are treading on without looking at own steps. As a result, it makes easier for the player to operate the foot switches “FSJ”, and furthermore the player can concentrate on the television monitor 1.

For example, the response objects 114-2 and 114-3 remain the different form as illustrated in FIG. 6 while the player remains standing on the stepping regions 46-2 and 46-3.

In addition, since a plurality of different music pieces is played back in this embodiment, the player can enjoy stepping operation without growing weary.

Incidentally, the present invention is not limited to the above embodiments, and a variety of variations and modifications may be effected without departing from the spirit and scope thereof, as described in the following exemplary modifications.

(1) In the above description, the response object “114-J” corresponding to the foot switch “FSJ” which is turned on by stepping becomes different form in order to show stepping position (refer to FIG. 6). However, the change of form is not limited to the example explained above. In what follows, several examples are explained.

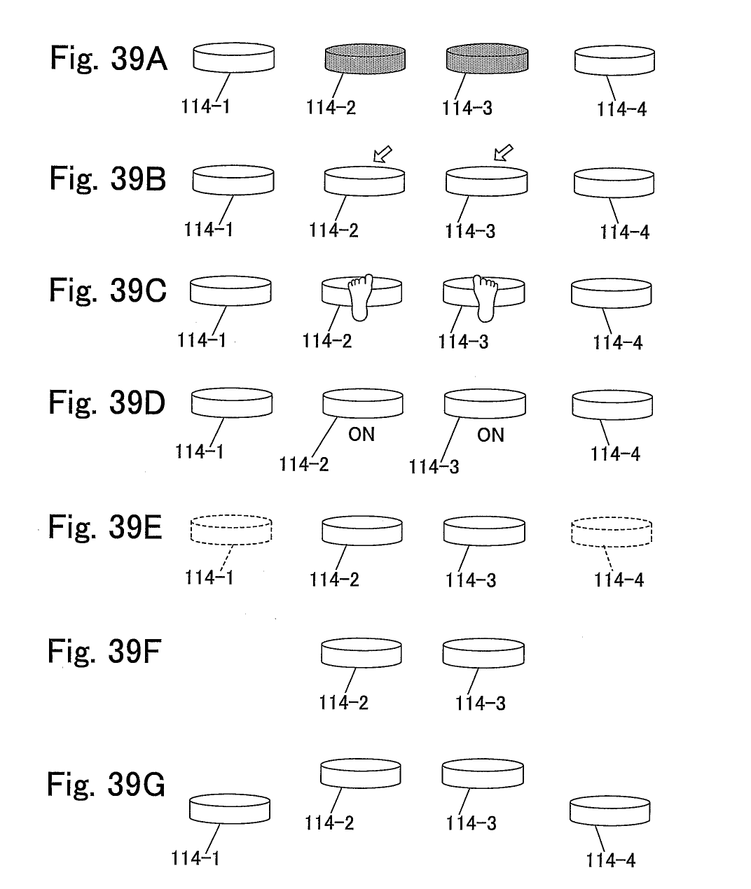

FIG. 39A to 39G are views showing examples of images showing stepping position in the present invention. In the examples of FIG. 39A to 39G, the foot switches FS2 and FS3 are turned on.

In FIG. 39A, the response objects 114-2 and 114-3 corresponding to the foot switches FS2 and FS3 which are turned on becomes different color. In FIG. 39B, arrows are displayed to point the response objects 114-2 and 114-3 corresponding to the foot switches FS2 and FS3 which are turned on.

In FIG. 39C, footprint images are displayed on the response objects 114-2 and 114-3 corresponding to the foot switches FS2 and FS3 which are turned on. In FIG. 39D, words “ON” are displayed below the response objects 114-2 and 114-3 corresponding to the foot switches FS2 and FS3 which are turned on. In FIG. 39E, the response objects 114-1 and 114-4 corresponding to the foot switches FS1 and FS4 which are turned off are displayed in dashed line.

In FIG. 39F, the response objects 114-1 and 114-4 corresponding to the foot switches FS1 and FS4 which are turned off are transparent. In FIG. 39G, a position of the response objects 114-2 and 114-3 corresponding to the foot switches FS2 and FS3 which are turned on becomes different.

(2) In the above description, the player can select play time in the fitness mode. It is possible to allow the player to select a number of music to be played and/or a number of times music to be repeatedly played back.

(3) In the above description, the information processing apparatus 20 is attached to the mat 40. However, the information processing apparatus 20 can be separated from the mat 40. In this case, the information processing apparatus 20 and the mat 40 can be linked with each other by wired or wireless (e.g. radio wave or infrared ray) connections.

(4) While any appropriate processor can be used as the high speed processor 200 of FIG. 12, it is preferred to use the high speed processor in relation to which the applicant has been filed patent applications. The details of this high speed processor are disclosed, for example, in Jpn. unexamined patent publication No. 10-307790 and U.S. Pat. No. 6,070,205 corresponding thereto.

The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated.

1. A stepped position specifying apparatus connected to a display device when being used, said stepped position specifying apparatus comprising:
a mat which has a plurality of foot switches operable to detect stepping operation;
an image generating unit operable to generate images of a plurality of response objects which are responsive respectively to the operation of the corresponding foot switch, and display the images on the display device; and
a response object control unit operable to, during the period when the foot switch is turned on, display the corresponding response object in a different manner from the response object displayed while the foot switch is being turned off.

2. The stepped position specifying apparatus as claimed in claim 1 wherein said response object control unit, during the period when the foot switch is turned on, displays the corresponding response object in a different form from the response object displayed while the foot switch is being turned off.

3. The stepped position specifying apparatus as claimed in claim 2 wherein the different form of the response object is expressed by shape, pattern, color or combination thereof.

4. A stepping type exercise apparatus which is used with being connected to a display device, said stepping type exercise apparatus comprising:
a mat which has a plurality of foot switches operable to detect stepping operation;
an image generating unit operable to generate images of a plurality of response objects which are responsive respectively to the operation of the corresponding foot switch and images of moving objects which move in motion lanes corresponding to the response objects, and display the images on the display device; and
a music play back unit operable to play back music in accordance with musical score data;
a moving object control unit operable in order that each moving object is displayed on the motion lane corresponding to each moving object in accordance with display timing setting data which is used to set display timing in synchronization with the music; and
a response object control unit operable to change, when the foot switch is operated, the way of displaying the response object corresponding to the operated foot switch,
wherein said moving object control unit moves the moving object along the corresponding motion lane, and changes the way of displaying the moving object if the corresponding foot switch is operated while the moving object is located within a predetermined area of the corresponding motion lane, and
wherein said response object control unit displays, during the period when the foot switch is turned on, the corresponding response object in a different manner from the response object displayed while the foot switch is being turned off.

5. A stepping type exercise apparatus which is used with being connected to a display device, said stepping type exercise apparatus comprising:
a mat which has a plurality of foot switches operable to detect stepping operation;
an image generating unit operable to generate images of a plurality of response objects which are responsive respectively to the operation of the corresponding foot switch and images of moving objects which move in motion lanes corresponding to the response objects, and display the images on the display device; and
a music play back unit operable to play back music in accordance with musical score data;
a moving object control unit operable in order that each moving object is displayed on the motion lane corresponding to each moving object in accordance with display timing setting data which is used to set display timing in synchronization with the music; and
an response object control unit operable to change, when the foot switch is operated, the way of displaying the response object corresponding to the operated foot switch,
a playing time setting unit operable to set a playing time in response to information input by a player;
an exit control unit operable, after the playing time that is set elapses, to control said music play back unit to stop play backing the music, and/or to control said image generating unit to generate an image which directly or indirectly indicates the end,
wherein said moving object control unit moves the moving object along the corresponding motion lane, and changes the way of displaying the moving object if the corresponding foot switch is operated while the moving object is located within a predetermined area of the corresponding motion lane.

6. A stepping type exercise apparatus which is used with being connected to a display device, said stepping type exercise apparatus comprising:
a mat which has a plurality of foot switches operable to detect stepping operation;
an image generating unit operable to generate images of a plurality of response objects which are responsive respectively to the operation of the corresponding foot switch and images of moving objects which move in motion lanes corresponding to the response objects, and display the images on the display device; and
a music play back unit operable to play back music in accordance with musical score data;
a moving object control unit operable in order that each moving object is displayed on the motion lane corresponding to each moving object in accordance with display timing setting data which is used to set display timing in synchronization with the music; and
an response object control unit operable to change, when the foot switch is operated, the way of displaying the response object corresponding to the operated foot switch,
a number setting unit operable to set the number of music pieces to be played back or the number of times the music is played back in accordance with information which is input by a player; and
an exit control unit operable to control said image generating unit to generate an image which directly or indirectly indicates the end after completion of play back of the music through the number of music pieces or the number of times that is set,
wherein said moving object control unit moves the moving object along the corresponding motion lane, and changes the way of displaying the moving object if the corresponding foot switch is operated while the moving object is located within a predetermined area of the corresponding motion lane.

7. The stepping type exercise apparatus as claimed in claim 5,
wherein said music play back unit play backs a plurality of different music pieces in a fixed order or in an order which is dynamically determined, and
wherein said moving object control unit appear makes each moving object appear on the motion lane corresponding to each moving object in accordance with display timing setting data which is used to set display timing in synchronization with the music.

8. The stepping type exercise apparatus as claimed in claim 6,
wherein said music play back unit play backs a plurality of different music pieces in a fixed order or in an order which is dynamically determined, and
wherein said moving object control unit appear makes each moving object appear on the motion lane corresponding to each moving object in accordance with display timing setting data which is used to set display timing in synchronization with the music.

9. The stepping type exercise apparatus as claimed in claim 5 wherein said response object control unit, during the period when the foot switch is turned on, displays the corresponding response object in a different manner from the response object displayed while the foot switch is being turned off.

10. The stepping type exercise apparatus as claimed in claim 6 wherein said response object control unit, during the period when the foot switch is turned on, displays the corresponding response object in a different manner from the response object displayed while the foot switch is being turned off.

11. A stepped position specifying method comprising:
displaying a plurality of response objects which are responsive respectively to operation of the corresponding foot switch which detects stepping operation;
displaying, during the period when the foot switch is turned on, the corresponding response object in a different manner from the response object displayed while the foot switch is being turned off.

12. An exercising support method comprising:
playing back music in accordance with musical score data;
displaying a plurality of response objects which are responsive respectively to operation of the corresponding foot switch which detects stepping operation;
displaying a plurality of moving objects moving in motion lanes corresponding to the response objects;
displaying, during the period when the foot switch is turned on, the corresponding response object in a different manner from the response object displayed while the foot switch is being turned off,
the step of displaying the plurality of moving objects including:
displaying each moving object on the motion lane corresponding to each moving object in accordance with display timing setting data which is used to set display timings in synchronization with the music; and
changing the way of displaying the moving object if the corresponding foot switch is operated while the moving object is located within a predetermined area of the corresponding motion lane.

13. An exercising support method comprising:
playing back music in accordance with musical score data;
displaying a plurality of response objects which are responsive respectively to operation of the corresponding foot switch which detects stepping operation;
displaying a plurality of moving objects moving in motion lanes corresponding to the response objects;
setting a playing time in response to information input by a player;
after the playing time that is set elapses, stopping playing back the music, and/or generating an image which directly or indirectly indicates the end,
the step of displaying the plurality of moving objects including:
displaying each moving object on the motion lane corresponding to each moving object in accordance with display timing setting data which is used to set display timings in synchronization with the music; and
changing the way of displaying the moving object if the corresponding foot switch is operated while the moving object is located within a predetermined area of the corresponding motion lane.

14. An exercising support method comprising:
playing back music in accordance with musical score data;
displaying a plurality of response objects which are responsive respectively to operation of the corresponding foot switch which detects stepping operation;
displaying a plurality of moving objects moving in motion lanes corresponding to the response objects;
setting the number of music pieces to be played back or the number of times the music is played back in response to information input by a player; and
after completion of play back of the music through the number of music pieces or the number of times that is set, stopping playing back the music, and/or generating an image which directly or indirectly indicates the end,
the step of displaying the plurality of moving objects including:
displaying each moving object on the motion lane corresponding to each moving object in accordance with display timing setting data which is used to set display timings in synchronization with the music; and
changing the way of displaying the moving object if the corresponding foot switch is operated while the moving object is located within a predetermined area of the corresponding motion lane.

15. The exercising support method as claimed in claim 13 wherein the step of playing back the music plays back a plurality of music in accordance with an order decided dynamically or a fixed order.

16. The exercising support method as claimed in claim 14 wherein the step of playing back the music plays back a plurality of music in accordance with an order decided dynamically or a fixed order.

17. The exercising support method as claimed in claims 13 further comprising a step of displaying, during the period when the foot switch is turned on, the corresponding response object in a different manner from the response object displayed while the foot switch is being turned off.

18. The exercising support method as claimed in claims 14 further comprising a step of displaying, during the period when the foot switch is turned on, the corresponding response object in a different manner from the response object displayed while the foot switch is being turned off.
